(19) United States
(12) Patent Application Publication
(10) Pub. No.: US 2016/0359169 A1
(43) Pub. Date: Dec. 8, 2016

(54) AQUEOUS PASTE FOR ELECTROCHEMICAL CELL, ELECTRODE PLATE FOR ELECTROCHEMICAL CELL OBTAINED BY APPLYING THE AQUEOUS PASTE, AND BATTERY COMPRISING THE ELECTRODE PLATE

(71) Applicants: MITSUI CHEMICALS, INC., Tokyo (JP); SHARP KABUSHIKI KAISHA, Osaka (JP)

(72) Inventors: Gen MIYATA, Ichihara-shi (JP); Akinori ETOH, Ichihara-shi (JP); Takehito MITATE, Osaka (JP); Naoto NISHIMURA, Osaka (JP); Takahiro MATSUYAMA, Osaka (JP); Syumpei NISHINAKA, Osaka (JP)

(73) Assignees: MITSUI CHEMICALS, INC., Tokyo (JP); SHARP KABUSHIKI KAISHA, Osaka (JP)

(21) Appl. No.: 15/241,732

(22) Filed: Aug. 19, 2016

Related U.S. Application Data
(62) Division of application No. 13/510,623, filed on May 17, 2012, now abandoned.

(30) Foreign Application Priority Data
Nov. 18, 2009 (JP) 2009-263179
Mar. 30, 2010 (JP) 2010-079604

(51) Int. Cl. H01M 4/62; H01M 10/0569; H01M 10/0568; H01M 4/04; H01M 4/58; H01M 4/133; H01M 4/583; H01M 10/0525; H01M 4/136

(52) U.S. Cl. CPC H01M 4/622; H01M 10/0525; H01M 10/0569; H01M 10/0568; H01M 4/136; H01M 4/5825; H01M 4/133; H01M 4/583; H01M 4/625; H01M 4/0404; H01M 2004/027

(57) ABSTRACT

The aqueous paste for an electrochemical cell of the present invention comprises an aqueous dispersion for an electrochemical cell that comprises an olefin copolymer (a); an active material; and a conductive assistant, wherein the olefin copolymer (a) has a weight average molecular weight of not less than 50,000 and is at least one kind selected from a random propylene copolymer (a-1) containing 50% by weight to less than 85% by weight of a structural unit derived from propylene; an acid-modified random propylene copolymer (a-2) obtained by modifying the copolymer (a-1) with an acid; and an ethylene-(meth)acrylic acid copolymer (a-3) containing 5% by weight to less than 25% by weight of a structural unit derived from (meth)acrylic acid.

### CROSS-REFERENCE TO RELATED APPLICATIONS

The present application is a divisional of U.S. patent application Ser. No. 13/510,623, filed May 17, 2012, which is a U.S. national stage application claiming the benefit of International Patent Application No. PCT/JP2010/070586, filed Nov. 18, 2010, which claims the benefit of priority to Japanese Patent Application No. 2009-263179, filed Nov. 18, 2009, and Japanese Patent Application No. 2010-079604, filed Mar. 30, 2010, the entireties of which are hereby incorporated by reference.

### TECHNICAL FIELD

The present invention relates to an aqueous paste for an electrochemical cell comprising an aqueous dispersion for an electrochemical cell that comprises a specific olefin copolymer (a); an active material; and a conductive assistant. The present invention also relates to an electrode plate for an electrochemical cell obtained by applying the aqueous paste; and a battery comprising the electrode plate.

Moreover, the present invention relates to an aqueous dispersion for an electrochemical cell (A) constituting a secondary battery, e.g., an alkaline secondary battery obtained by using a hydrogen-absorbing alloy (Ni-MH battery) and a non-aqueous electrolyte solution secondary battery obtained by using a lithium compound (lithium-ion battery) or constituting a storage device such as an electric double layer capacitor. More specifically, the present invention relates to an aqueous dispersion for an electrochemical cell (A) obtained by dispersing the specific olefin copolymer (a) in water.

### BACKGROUND ART

In the Ni-MH battery, the lithium-ion battery and the capacitor, an active material for a positive electrode and an active material for a negative electrode are bound by binders to respective collectors thereby preparing respective electrodes. As the binder for the positive electrode, which is required to have oxidation resistance, a solution obtained by dissolving polyvinylidene fluoride (PVDF) in N-methyl-2-pyrrolidone (NMP), or a fluorine-containing aqueous dispersion of polytetrafluoroethylene (PTFE) is used. As the binder for the negative electrode, in addition to PVDF, a styrene-butadiene rubber (SBR) aqueous dispersion is used.

However, these binders for the positive electrode, though having oxidation resistance, have inferior adhesion to active materials and collectors, thus needing to be added in a large amount. As a result, these binders coat the active materials, lowering battery properties. SBR, though having relatively high adhesion and needing not be blended in so large an amount, have high affinity with active materials, thus easily coating the surfaces of the electrodes. Furthermore, since PVDF and SBR have high affinity with electrolyte solutions, leaving the battery under high temperature or repeatedly charging and discharging the battery swells the resins and thus easily swells the battery.

In order to solve these problems, study has been undertaken to use, as a binder, an aqueous dispersion of an olefin copolymer that is electrochemically stable and swells less in an electrolyte solution (For example, Patent Documents 1 and 2). These binders have excellent redox resistance and swell less in an electrolyte solution, and hardly coat the active materials.

These binders, however, have relatively low adhesion as compared with SBR, and thus have insufficient cycle properties, one of the important characteristics of the battery.

Patent Document 3 discloses an aqueous dispersion containing an acid-modified polyolefin resin, and a secondary battery electrode obtained by using the aqueous dispersion.

However, this binder, using a water-soluble organic solvent as an aqueous medium, allows a slight amount of the organic solvent to remain therein. This organic solvent greatly deteriorates battery performance (in particular, irreversible capacity). Furthermore, this aqueous dispersion has not yet met the environmental demand for an aqueous dispersion free of VOC (volatile organic compound).

### CITATION LIST

### Patent Documents

### Patent Document 1: JP-A-9-251856

### Patent Document 2: JP-A-2009-110883

### Patent Document 3: JP-A-2010-189632

### SUMMARY OF THE INVENTION

### Problem to be Solved by the Invention

The present invention seeks to solve such problems as described above associated with conventional technique. It is an object of the present invention to provide an aqueous dispersion for an electrochemical cell (A) and an aqueous paste for an electrochemical cell that have sufficient adhesion to a metal collector, a positive electrode active material and a negative electrode active material and that allows a battery to be electrochemically stable and hardly swells the electrochemical cell, and particularly allows a secondary battery to have improved cycle properties while maintaining conventional electrostatic capacity and internal resistance.

It is another object of the present invention to provide an electrode plate comprising the aqueous paste for an electrochemical cell, and a battery comprising the electrode plate having high charge-discharge cycle life.

### Means for Solving the Problem

The present inventors earnestly studied the above problems and have found out that the above problems can be overcome by using an emulsion (an aqueous dispersion for an electrochemical cell (A)) obtained by emulsifying/dispersing a specific olefin copolymer (a) in water.

In the present invention, the specific olefin copolymer (a) is also referred to as a binder for an electrochemical cell.

In the present invention, the modification (modified product) means subjecting e.g., the olefin copolymer (a), polyoxyethylene, polyvinyl alcohol or the like to e.g., polymerization reaction, graft reaction, addition reaction or substitution reaction thereby allowing such compounds to have structures different from their main structures.

The aqueous paste for an electrochemical cell of the present invention comprises an aqueous dispersion for an electrochemical cell (A) that comprises an olefin copolymer (a); an active material (B); and a conductive assistant (C), wherein the olefin copolymer (a) has a weight average molecular weight, as determined by gel permeation chromatography (GPC), of not less than 50,000 (in terms of polystyrene) and is at least one kind selected from:

a random propylene copolymer (a-1) containing 50% by weight to less than 85% by weight of a structural unit derived from propylene,

an acid-modified random propylene copolymer (a-2) obtained by modifying the random propylene copolymer (a-1) with an acid, and

an ethylene-(meth)acrylic acid copolymer (a-3) containing 5% by weight to less than 25% by weight of a structural unit derived from (meth)acrylic acid.

Based on 100 parts by weight of the active material (B), the amount of a solid content of the aqueous dispersion (A) is preferably 0.5 to 30 parts by weight, and the amount of the conductive assistant (C) is preferably 0.1 to 20 parts by weight.

The random propylene copolymer (a-1) is preferably at least one kind selected from a random propylene-butene copolymer, a random ethylene-propylene-butene copolymer and a random ethylene-propylene copolymer.

The aqueous dispersion preferably further comprises an acid-modified olefin (co)polymer (a-4) having a weight average molecular weight, as determined by gel permeation chromatography (GPC), of less than 50,000 (in terms of polystyrene).

The acid-modified olefin (co)polymer (a-4) is preferably contained in an amount of 5 to 50 parts by weight based on 100 parts by weight of the total of the random propylene copolymer (a-1) and the acid-modified random propylene copolymer (a-2).

The acid modification is preferably maleic acid modification.

The aqueous dispersion (A) preferably comprises at least one kind selected from a surfactant (x) and a viscosity modifier (y).

Based on 100 parts by weight of a solid content of the olefin copolymer (a), the amount of a solid content of the surfactant (x) is preferably 0 to 100 parts by weight, and the amount of a solid content of the viscosity modifier (y) is preferably 10 to 100 parts by weight.

The viscosity modifier (y) is preferably at least one kind selected from carboxymethyl cellulose, polyethylene oxide, a modified product of polyethylene oxide, polyvinyl alcohol and a modified product of polyvinyl alcohol.

The active material (B) preferably comprises olivine LiFePO₄.

The olivine LiFePO₄ preferably has a median diameter (D50), as measured by laser diffraction scattering method, of 0.5 to 9 μm, and preferably has a specific surface area of 5 to 30 m²/g.

The active material (B) preferably comprises spherical natural graphite.

The spherical natural graphite preferably has a median diameter (D50), as measured by laser diffraction scattering method, of 15 to 20 μm, and preferably has a specific surface area of 2 to 5 m²/g.

The conductive assistant (C) is preferably at least one kind selected from acetylene black and artificial graphite, and the conductive assistant (C) preferably has a specific surface area of 2 to 80 m²/g.

The acetylene black preferably has a median diameter (D50), as measured by laser diffraction scattering method, of 0.02 to 5 μm.

The artificial graphite preferably has a median diameter (D50), as measured by laser diffraction scattering method, of 2 to 80 μm.

In an embodiment of the present invention, the electrode plate for an electrochemical cell obtained by applying the aqueous paste for an electrochemical cell of the present invention preferably has an electricity capacity of 0.5 to 18 mAh/cm².

In an embodiment of the present invention, the amount of the active material applied on a positive electrode plate (1) for an electrochemical cell obtained by applying the aqueous paste for electrochemistry of the present invention comprising olivine LiFePO₄ as the plate active material (B) is preferably 4 to 90 mg/cm², and the packing density of the active material applied on the positive electrode plate (1) is preferably 1.0 to 2.0 g/cm³.

In an embodiment of the present invention, the amount of the active material applied on a negative electrode plate (1) for an electrochemical cell obtained by applying the aqueous paste for electrochemistry of the present invention comprising spherical natural graphite as the plate active material (B) is preferably 2 to 50 mg/cm², and the packing density of the active material applied on the negative electrode plate (1) is preferably 1.0 to 1.7 g/cm³.

In an embodiment of the present invention, a non-aqueous electrolyte secondary battery is preferably obtained by using the positive electrode plate (1) and the negative electrode plate (1).

In an embodiment of the present invention, a household storage battery preferably uses the above non-aqueous electrolyte secondary battery.

The aqueous dispersion for an electrochemical cell (A) of the present invention comprises an olefin copolymer (a) that has a weight average molecular weight, as determined by gel permeation chromatography (GPC), of not less than 50,000 (in terms of polystyrene) and is at least one kind selected from:

a random propylene copolymer (a-1) containing 50% by weight to less than 85% by weight of a structural unit derived from propylene,

an acid-modified random propylene copolymer (a-2) obtained by modifying the random propylene copolymer (a-1) with an acid, and

an ethylene-(meth)acrylic acid copolymer (a-3) containing 5% by weight to less than 25% by weight of a structural unit derived from (meth)acrylic acid.

The aqueous dispersion (A) preferably comprises at least one kind selected from a surfactant (x) and a viscosity modifier (y).

### Effects of the Invention

The aqueous dispersion for an electrochemical cell (A) and the aqueous paste for an electrochemical cell, of the present invention, have sufficient adhesion to a metal collector, a positive electrode active material and a negative electrode active material. Moreover, they allow a battery to be electrochemically stable and hardly swell the electrochemical cell, and in particular allow a secondary battery to have improved cycle properties.

The use of the aqueous paste for an electrochemical cell of the present invention can efficiently produce electrodes.

Furthermore, the battery comprising the electrode plates obtained using the aqueous paste for an electrochemical cell has high charge-discharge cycle life.

Accordingly, a high efficiency battery having smaller size, smaller weight and higher capacity can be obtained.

### BRIEF DESCRIPTION OF DRAWINGS

FIG. 1 is a schematic cross-sectional view of a non-aqueous electrolyte secondary battery of an embodiment of the present invention.

FIG. 2 is a perspective view of an electrode plate in flexure test.

FIG. 3 is a lateral view of an electrode plate in flexure test.

### EMBODIMENTS FOR CARRYING OUT THE INVENTION

### <Aqueous Paste for an Electrochemical Cell>

A paste for an electrochemical cell of the present invention comprises a specific aqueous dispersion for an electrochemical cell (A), an active material (B) and a conductive assistant (C).

### [Aqueous Dispersion for an Electrochemical Cell (A)]

The aqueous dispersion for an electrochemical cell (A) of the present invention is an emulsion dispersed in water.

The aqueous dispersion (A) comprises, in addition to the olefin copolymer (a) according to the present invention, a component such as a surfactant (x) and a viscosity modifier (y) as needed.

The amount of solid contents of the aqueous dispersion (A) (i.e., the total amount of solid contents of the copolymer (a) and the surfactant (x) and a solid content of the viscosity modifier (y)) is preferably 0.5 to 30 parts by weight, more preferably 1 to 20 parts by weight, based on 100 parts by weight of the active material. This range ensures the accomplishment of good electrode-plate adhesion, and thus is preferred. An amount of less than 0.5 part by weight may cause the mix layers to be peeled from collectors of the electrode plates. An amount of more than 30 parts by weight may decrease lithium ion-transporting properties.

The aqueous dispersion (A) according to the present invention comprises resin particles composed of an olefin copolymer (a) having a volume average particle diameter, which is not particularly limited, of 10 to 1,000 nm, preferably 10 to 800 nm, more preferably 10 to 500 nm (determined with Microtrac HRA: Honneywell International Inc.). The particle diameter falling within the above range ensures excellent aqueous dispersion stability, and thus is preferred. A particle diameter of less than 10 nm may decrease electrode-plate adhesion, while a particle diameter of more than 1,000 nm may impair dispersion stability. The preparation of electrodes using the aqueous dispersion comprises applying the aqueous paste according to the present invention on collectors and drying. This range can prevent so-called migration of the olefin copolymer (a) that occurs with the evaporation of the moisture, in which the olefin copolymer (a) transfers to the direction opposite to the collectors and thereby the adhesion to the collectors is decreased. A range exceeding this range leads to excessive migration or decreases contact area, which may result in decreased adhesion or the like. The particle diameter can be arbitrarily controlled by a method, which is not particularly limited, for example, by controlling melting temperature, resin neutralization amount, emulsifying assistant amount and the like in production.

### (Olefin Copolymer (a))

The use of the olefin copolymer (a) according to the present invention in the aqueous dispersion (A) can provide good adhesion and battery cycle performance.

The olefin copolymer (a) is contained in an amount in terms of a solid content of 5 to 80% by weight, preferably 10 to 70% by weight, in the aqueous dispersion (A). This range ensures the accomplishment of good electrode-plate adhesion.

The copolymer (a) usually has a melting point [Tm], as measured by differential scanning calorimetry (DSC), of not higher than 120° C. or not being observed, preferably not higher than 110° C. or not being observed. The melting point falling within the above range ensures excellent electrode-plate flexibility, and thus is preferred. A melting point of higher than 120° C. may lead to insufficient electrode-plate flexibility and impaired processability. The olefin copolymer (a) may have or may not have crystallinity, but preferably has a crystallinity, as determined by X-ray diffraction method, of not more than 30% in terms of cycle properties of the secondary battery and adhesion to various substrates.

The olefin copolymer (a) comprises at least one kind selected from a copolymer (a-1) to a copolymer (a-3) described below. Moreover, the olefin copolymer (a) preferably comprises a (co)polymer (a-4), more preferably the (co)polymer (a-4) and/or a copolymer (a-5), each of which is described below. These (co)polymers may be arbitrarily used.

(Random Propylene Copolymer (a-1))

The random propylene copolymer (a-1) contains a structural unit derived from propylene as a main component, and further contains an α-olefin such as ethylene, 1-butene, 4-methylpentene-1, 1-hexene, 1-heptene, 1-octene, 1-nonene, 1-decene, 1-undecene, 1-dodecene, 1-tridecene, 1-tetradecene, 1-pentadecene, 1-hexadecene, 1-heptadecene, 1-nonadecene, 1-eicosene, 9-methyldecene-1, 11-methyldodecene-1 and 12-ethyltetradecene-1 as a copolymerization component. Only one kind of these copolymers may be used, or plural kinds of these copolymers may be used in combination.

Of these, a random propylene-butene copolymer, a random ethylene-propylene-butene copolymer and a random ethylene-propylene copolymer are preferable in terms of electrode-plate flexibility.

The copolymer (a-1) has a weight average molecular weight, as determined by gel permeation chromatography (GPC) in terms of polystyrene, of from not less than 50,000 to an upper limit which is not particularly limited. The copolymer (a-1) preferably has a weight average molecular weight of 50,000 to 500,000, more preferably 50,000 to 300,000 in terms of controlling the diameter of dispersed particles in the aqueous dispersion prepared. The copolymer (a-1) having a weight average molecular weight of less than 50,000 represents a binder that has insufficient strength when binding the active material and causes the peeling of the mix layers on the electrodes.

With regard to the content of the copolymerization component, in terms of impact resistance, flexibility, adhesive strength of the electrode plates for an electrochemical cell, particularly in terms of cycle properties of the electrodes, the content of the structural unit derived from propylene is 50% by weight to less than 85% by weight, preferably 50 to 80% by weight, more preferably 55 to 80% by weight, based on 100% by weight of the copolymer (a-1).

(Acid-Modified Random Propylene Copolymer (a-2))

The acid-modified random propylene copolymer (a-2) is a copolymer obtained by modifying the random propylene copolymer (a-1) with an acid. For the purpose of the bonding with metal collectors, the use of the copolymer modified with an acid is preferable.

The copolymer (a-2) has the same weight average molecular weight as that of the copolymer (a-1).

The acid is not particularly limited in its type as long as being a compound capable of modifying the random propylene copolymer (a-1). Examples thereof include carboxylic acid and sulfonic acid. Of these, carboxylic acid is preferable in terms of adhesion. Further examples include maleic acid and benzoic acid having an unsaturated bond, and derivatives thereof. In particular, a maleic-modified random polypropylene, obtained by modification with maleic acid, is preferable in terms of the number of acid functional groups. In terms of electrode-plate flexibility, more preferable are a maleic-modified random propylene-butene copolymer, a maleic-modified random ethylene-propylene-butene copolymer and a maleic-modified random ethylene-propylene copolymer.

A higher degree of acid modification (modification degree) causes increased viscosity of the emulsion and increased resin swell in an electrolyte solution. In view of this, the modification degree is usually within a range of 0.1 to 5.0% by weight in terms of an acid. In the case of the modification with maleic acid, for example, the modification degree in terms of maleic anhydride is preferably 0.5 to 4.0% by weight (maleic-modification degree: 0.5 to 4.0), more preferably 0.5 to 2.0% by weight (maleic-modification degree: 0.5 to 2.0).

The method of modification with maleic acid, which is not particularly limited, is for example, a method in which the random propylene copolymer (a-1) is dissolved or dispersed in a hydrocarbon solvent at high temperature and thereto, maleic anhydride and an organic peroxide are added to thereby add maleic anhydride, or a method in which while the random propylene copolymer (a-1) is continuously melt kneaded with a biaxial extruder, an organic peroxide and maleic anhydride are continuously added thereto to thereby allow these components to react with one another within the extruder.

(Ethylene-(Meth)Acrylic Acid Copolymer (a-3))

The ethylene-(meth)acrylic acid copolymer (a-3) contains a structural unit derived from (meth)acrylic acid in an amount of 5% by weight to 25% by weight, preferably 6 to 20% by weight, more preferably 10 to 20% by weight in terms of electrode-plate adhesion. The content of the structural unit of less than 5% by weight causes the aqueous dispersion to have decreased stability and causes the binder to have decreased adhesion. The ethylene-(meth)acrylic acid copolymer (a-3) containing more than 25% by weight of the structural unit does not provide an aqueous dispersion but provides a water-soluble polymer having decreased binding properties when added in a small amount range.

The copolymer (a-3) has the same weight average molecular weight as that of the copolymer (a-1).

Desirably, the (meth)acrylic acid has been neutralized with an alkali. The alkali type is not particularly limited, and examples thereof include ammonia, organic amines and alkali metals such as potassium hydroxide, sodium hydroxide and lithium hydroxide. In particular, ammonia, sodium hydroxide and lithium hydroxide are suitable for the preparation of the aqueous dispersion.

The neutralization degree of carboxylic acid possessed by the (meth)acrylic acid, which is not particularly limited, is desirably 25 mol % to 85 mol %. A neutralization degree of lower than 25 mol % may decrease the stability of the aqueous dispersion, while a neutralization degree of higher than 85 mol % may cause the shortage of carboxylic acid that has not been neutralized thereby decreasing the adhesion as a binder. The neutralization degree is preferably 30 mol % to 80 mol %, more preferably 35 mol % to 75 mol %.

The copolymer (a-3) in the olefin copolymer (a) may be contained in an amount of 100% by weight with respect to the olefin copolymer (a). When a mixture of the copolymer (a-1) and the copolymer (a-2) is contained, the copolymer (a-3) is contained preferably in amount of 0 to 200 parts by weight, more preferably 0.5 to 150 parts by weight, based on 100 parts by weight of the total of the copolymer (a-1) and the copolymer (a-2).

(Acid-Modified Olefin (Co)Polymer (a-4))

The acid-modified olefin (co)polymer (a-4) is a co (polymer) modified with an acid. Examples of the olefin co (polymer) include homopolymers having 2 to 6 carbon atoms such as polyethylene and polypropylene, and copolymers obtained by copolymerizing olefins having 2 to 6 carbon atoms. The acid-modified olefin (co)polymer (a-4) is, in particular, a propylene homopolymer, or a copolymer that is a random copolymer or block copolymer of propylene with an α-olefin having 2 to 6 carbon atoms excluding propylene, the copolymer usually containing not less than 50 mol %, preferably not less than 60 mol % of a unit derived from propylene in 100 mol % of the total of the unit derived from propylene and a unit derived an α-olefin having 2 to 6 carbon atoms excluding propylene.

The acid types and acid modification method are as described with regard to the copolymer (a-2). The acid is preferably maleic acid in terms of the number of acid functional groups.

The (co)polymer (a-4) has a weight average molecular weight, as determined by GPC in terms of polystyrene, of less than 50,000, preferably 5,000 to less than 50,000, more preferably 5,000 to 40,000. In the present invention, the copolymer (a-4), having a low molecular weight, serves as being a dispersing agent in dispersing the olefin copolymer (a), as improving kneading stability when the aqueous dispersion (A) is kneaded with the electrode active material, as improving electrode-plate (mix layer) adhesion and moreover as improving the compatibility with a thickening agent (a viscosity modifier), in particular, carboxymethyl cellulose.

In particular, preferred is a maleic-modified olefin (co)polymer having a low molecular weight, i.e., having a weight average molecular weight of less than 50,000, preferably maleic-modified polypropylene, in terms of the compatibility with the random propylene copolymer (a-1) or the acid-modified random propylene copolymer (a-2) in the step of preparing the aqueous dispersion.

The modification degree is usually 0.1 to 10% by weight, preferably 0.5 to 8% by weight, in terms of aqueous dispersion stability and electrode-plate adhesion. A range exceeding the above may decrease emulsifiability in emulsifying/dispersing, decrease paste kneading stability or increase the viscosity of the paste.

The (co)polymer (a-4) is contained preferably in an amount of 5 to 50 parts by weight, more preferably 10 to 40 parts by weight, still more preferably 10 to 30 parts by weight, based on 100 parts by weight of the total of the random propylene copolymer (a-1) and the acid-modified random propylene copolymer (a-2), in terms of adhesion of the olefin copolymer (a) and swell of the olefin copolymer (a) in an electrolyte solution and also in terms of emulsifiability in emulsifying/dispersing and paste kneading stability.

(Other Copolymer (a-5))

The olefin copolymer (a) according to the present invention may comprise other copolymer (a-5) in a range that is not detrimental to the effect of the present invention.

As the other copolymer (a-5), examples include copolymers which are different from the copolymers (a-1) to (a-4) and which are obtained by using a single kind of or combining two or more kinds of copolymerizable monomers such as styrene, ethylene, propylene, 1-butene, 1,3-butadiene, 3-methyl-1-butene, 4-methyl-1-pentene, 3-methyl-1-pentene, 1-heptene, 1-hexene, 1-octene, 1-decene and 1-dodecene; a styrene-ethylene-butylene copolymer; and hydrogenated products thereof.

Further employable examples include alicyclic structure-containing polymers such as norbornene polymers, monocyclic polyolefin polymers, cyclic conjugated diene polymers, vinyl alicyclic hydrocarbon polymers and hydrogenated products thereof.

Examples of the copolymer (a-5) include acid-modified products of these copolymers, and in particular, maleic-modified products are preferable.

Of these, the styrene-ethylene-butylene copolymer is preferable in terms of electrode-plate flexibility.

The content of the copolymer (a-5) is 0 to 50 parts by weight, preferably 0 to 30 parts by weight, based on 100 parts by weight of the olefin copolymer (a), in terms of improving glueability and electrode pliability. The content of the copolymer (a-5) is 0 to 50 parts by weight, preferably 0 to 30 parts by weight, based on 100 parts by weight of the total of the copolymers (a-1) and (a-2), in terms of improving glueability and electrode pliability.

When the copolymer modified with maleic acid is used, the maleic-modification degree is not particularly limited, but is preferably 0.1 to 10% by weight, more preferably 0.1 to 8% by weight. A range exceeding the above may decrease emulsifiability in emulsifying/dispersing, decrease paste kneading stability or may increase the viscosity of the paste.

The copolymer (a-5) has a weight average molecular weight, which is not particularly limited, preferably in the range of 5,000 to 300,000.

### (Surfactant (x))

In the present invention, the surfactant (x) may be optionally added as an emulsifying agent. The surfactant is preferably contained in the aqueous dispersion (A).

A surfactant modifies hydrophilicity or hydrophobicity of a surface or an interface of a substance. In the present invention, the surfactant serves as a dispersant, a wetting agent and an antifoaming agent. The inclusion thereof is preferable in terms of dispersing the active material and the conductive assistant in water.

The surfactant is desirably an anionic surfactant, a nonionic surfactant or a silicon-based surfactant, but is not particularly limited. The addition amount in terms of a solid content of the surfactant is 0 to 100 parts by weight, preferably 3 to 80 parts by weight, based on 100 parts by weight of a solid content of the olefin copolymer (a) in the aqueous dispersion (A). A range exceeding the above causes increased compatibility of the resin particles with an electrolyte solution, which leads to the tendency of considerably decreased strength or swell of the resin.

Examples of the anionic surfactant include:

sulfonates having C10 to C20 saturated or unsaturated alkyl chains such as sodium dodecylbenzene sulfonate and sodium lauryl sulfate;

carboxylates having C10 to C20 saturated or unsaturated alkyl chains such as sodium alkyldiphenyl ether disulfonate, sodium alkylnaphthalene sulfonate, sodium dialkyl sulfosuccinate, sodium stearate and potassium oleate;

sodium dioctylsulfosuccinate, sodium polyoxyethylene alkylether sulfate, sodium polyoxyethylene alkylether sulfate, sodium polyoxyethylene alkylphenylether sulfate, sodium dialkyl sulfosuccinate, sodium stearate, sodium oleate and sodium t-octylphenoxy ethoxypolyethoxyethyl sulfate.

Examples of the nonionic surfactant include polyoxyethylene alkylethers such as polyoxyethylene laurylether and polyoxyethylene stearylether, polyoxyalkylene alkylethers, polyoxyethylene polyoxypropylene alkylethers, polyoxyethylene styrenated phenylether, polyoxyethylene distyrenated phenylether, polyoxyethylene octylphenylether, polyoxyethylene oleylphenylether, polyoxyethylene nonylphenylether, oxyethylene.oxypropylene block copolymer, t-octylphenoxyethylpolyethoxy ethanol, nonylphenoxyethylpolyethoxy ethanol and polyoxyethylene ether of acetylenic glycol derivatives.

Examples of the silicon-based surfactant include polydimethyl siloxane, polyether modified polydimethyl siloxane, polymethyl alkylsiloxane and silicon modified polyoxyethylene ether.

Only one kind of the surfactants may be used, or plural kinds of the surfactants may be combined and used.

Of these surfactants, in terms of dispersing the active material and the conductive assistant in water, potassium oleate and potassium stearate are preferable. In terms of lowering surface tension of water, polyoxyethylene ether of acetylenic glycol derivatives and silicon modified polyoxyethylene ether are preferable. The use as the surfactant of at least one kind selected from potassium oleate, polyoxyethylene ether of acetylenic glycol derivatives and silicon modified polyoxyethylene ether is preferable because of allowing the active material and the conductive assistant to be well dispersed in the resultant aqueous dispersion.

When the copolymer (a-3) alone is used as the olefin copolymer (a), the aqueous dispersion (A) preferably contains the surfactant in terms of improving the dispersibility of the active material and the conductive assistant. Such a surfactant, which is not particularly limited, is preferably potassium oleate, potassium stearate, polyoxyethylene ether of acetylenic glycol derivatives or silicon modified polyoxyethylene ether; more preferably potassium oleate, polyoxyethylene ether of acetylenic glycol derivatives or silicon modified polyoxyethylene ether. In this case, the amount of the surfactant, which is not particularly limited, is in terms of a solid content, preferably 0 to 100 parts by weight, preferably 3 to 80 parts by weight in view of cycle properties, based on 100 parts by weight of a solid content of the copolymer (a-3). This range ensures the accomplishment of good capacity-retention ratio based on electrode-plate adhesion.

### (Viscosity Modifier (y))

In the present invention, the viscosity modifier (y) may be optionally added. The viscosity modifier is preferably contained in the aqueous dispersion (A).

The aqueous paste for an electrochemical cell of the present invention (an ink used to apply the positive electrode/negative electrode active materials on collectors) preferably comprises the viscosity modifier. The olefin copolymer (a) according to the present invention is an aqueous dispersion type polymer. Thus, the olefin copolymer (a) when using the viscosity modifier can provide the electrode paste with optimum viscosity, thus facilitating the applying of the electrode paste on the electrodes.

The blending of the viscosity modifier, when the paste is allowed to stand still, can prevent the active material, the conductive assistant and the like from settling and separating with the passage of time. The blending of the viscosity modifier is preferable also because of alleviating the separating and floating with the passage of time of the olefin copolymer (a) according to the present invention having a volume average particle diameter of more than 200 nm.

The addition amount of the viscosity modifier in terms of a solid content is 10 to 100 parts by weight, preferably 10 to 95 parts by weight, based on 100 parts by weight of a solid content of the olefin copolymer (a) in view of coatability and workability.

The viscosity modifier, which is not particularly limited, preferably has a weight average molecular weight, as determined by GPC, of 50,000 to 4,000,000 (in terms of polystyrene), more preferably 60,000 to 3,500,000, more preferably 65,000 to 3,000,000. A weight average molecular weight of less than 50,000 may cause the settling of the active material, while a weight average molecular weight of more than 4,000,000 may allow the paste to have considerable thixotropy. The range falling within the above ensures the accomplishment of good coatability for electrode plates and thus is preferred.

The viscosity modifier is not particularly limited. Examples thereof include cellulose derivatives such as carboxymethyl cellulose (CMC), carboxyethyl cellulose and hydroxyethyl cellulose; polyoxyethylene or modified products thereof; polyvinyl alcohol or modified products thereof; and polysaccharide.

Of these viscosity modifiers, in terms of settling stability, CMC, polyoxyethylene or modified products thereof and polyvinyl alcohol or modified products thereof are more preferable.

Only one kind of these viscosity modifiers may be used, or plural kinds of these viscosity modifiers may be used in combination.

### (Others)

The aqueous dispersion (A) according to the present invention may optionally comprise various additives such as heat stabilizers, anti-slip agents, blowing agents, crystallizing assistants, nucleating agents, pigments, dyes, plasticizers, anti-aging agents, antioxidants, impact resistance improvers, fillers, crosslinking agents, co-crosslinking agents, crosslinking assistants, tackifiers, softeners, flame retardants, processing assistants in a range that is not detrimental to the object of the present invention.

### [Active Material (B)]

The active material (B) is not particularly limited. Examples of an active material for a negative electrode include natural graphite and artificial graphite. Examples of an active material for a positive electrode include LiCoO₂, LiMn₂O₄ and LiFePO₄. Carbon materials for the conductive assistant may be arbitrarily used.

The negative electrode active material for a lithium-ion secondary battery, for example, is not particularly limited as long as being capable of doping and undoping lithium ions. Employable examples thereof include metal lithium, lithium alloys, tin oxide, niobium oxide, vanadium oxide, titanium oxide, silicon, transition metal nitrides, carbon materials such as natural graphite and composites thereof.

Examples of the positive electrode active material for a lithium-ion secondary battery include sulfur compounds such as Li₂S and S; composite oxides composed of lithium and a transition metal, such as LiCoO₂, LiMnO₂, LiMn₂O₄, LiNiO₂, LiNi_{X}Co_{(1-X)}O₂, LiNiₓMn_{y}Co_{(1-x-y)}, LiNiₓCo_{y}Al_{(1-x-y)} and Li₂MnO₃; phosphoric acid compounds such as LiFePO₄ and LiMnPO₄; and conductive polymer materials such as polyaniline, polythiophene, polypyrrole, polyacetylene, polyacene and dimercaptothiadiazole/polyaniline composite. Of these, in particular, composite oxides composed of lithium and a transition metal and phosphoric acid compounds such as LiFePO₄ and LiMnPO₄ are preferable. When lithium metal or a lithium alloy is used for the negative electrode, a carbon material may be used for the positive electrode. As the positive electrode, a mixture of the composite oxide of lithium and a transition metal with the carbon material may be used.

When the alkaline secondary battery is, for example, a nickel metal hydride secondary battery, examples employable as the active material for a positive electrode include nickel hydroxide and a composite of nickel hydroxide with cobalt or zinc.

Examples of the active material for a negative electrode include a hydrogen-absorbing alloy composed of manganese, nickel, cobalt, aluminum, a mischmetal and the like.

As a positive electrode/negative electrode active material for an electric double layer capacitor, various activated carbons are used.

### [Conductive Assistant (C)]

The conductive assistant (C) is not particularly limited. Examples thereof include carbon materials such as carbon black, amorphous whisker carbon, graphite, acetylene black and artificial graphite; conductive polymers such as polythiophene and polypyrrole and derivatives thereof; fine particles of metals such as cobalt. One kind of these may be used singly, or two or more kinds of these may be used in combination. Carbon materials for the active material may be arbitrarily used.

The amount of the conductive assistant is preferably 0.1 to 20 parts by weight, more preferably 0.2 to 15 parts by weight, based on 100 parts by weight of the active material. This range ensures the accomplishment of good lithium ion-transporting properties and electrical conductivity without impairing charge capacity. An amount of less than 0.1 part by weight may increase electrical resistance of the mix layers, while an amount of more than 20 parts by weight may decrease Li ion-transporting properties.

### [Preparation of Aqueous Dispersion for an Electrochemical Cell (A)]

The method of dispersing the olefin copolymer (a) in water is a publicly known one and is not particularly limited, but a preferred method is such that alkali water is added in a slight amount to the resin melt-kneaded in order to minimize the amount of an emulsifying assistant and an emulsifying agent (JP-B-7-008933).

Emulsifying/dispersing requires neutralization with an alkali. Types of the alkali for this purpose is not particularly limited, with examples thereof including ammonia, organic amines and alkali metals such as potassium hydroxide, sodium hydroxide and lithium hydroxide.

### [Electrochemical Cell]

In an embodiment of the present invention, the electrode for an electrochemical cell according to the present invention is obtained by using the aqueous dispersion for an electrochemical cell (A) comprising the olefin copolymer (a) of the present invention; the positive electrode active material for the positive electrode; the negative electrode active material for the negative electrode; and the conductive assistant, preferable examples of which include carbon materials such as carbon black, amorphous whisker carbon and graphite.

In an embodiment of the present invention, with regard to the electrochemical cell of the present invention, the secondary battery is prepared by laminating the positive electrodes and the negative electrodes described above with a separator placed at the center, forming the laminate so as to have cylindrical shape, coin shape, square shape, film shape or another desired shape, and enclosing a non-aqueous electrolyte solution.

The electric double layer capacitor is prepared by laminating the electrodes described above with a separator placed at the center, forming the laminate so as to have cylindrical shape, coin shape or another desired shape, and enclosing an electrolyte solution.

As the separator in the secondary battery, a porous film or a polymer electrolyte is used. Examples of the porous film include polyolefins, polyimides, polyvinylidene fluoride and polyesters. In particular, porous polyolefin films are preferable. Specific examples thereof include a porous polyethylene film, a porous polypropylene film and a multi-layer film of a porous polyethylene film with polypropylene. The porous polyolefin film may be coated with other resins excellent in heat stability.

As the separator in the electric double layer capacitor, employable examples in addition to the examples of the separator for the secondary battery include electrolytic capacitor paper and porous films containing inorganic ceramic powder.

In the secondary battery, as a non-aqueous electrolyte solution for lithium ions or the like, for example, a solution obtained by dissolving a single kind of or the combination of two or more kinds of electrolytes in an organic solvent may be used, the electrolytes being for example LiPF₆, LiBF₄, LiClO₄, LiAsF₆, CF₃SO₃Li and (CF₃SO₂)N/Li.

As an alkali electrolyte solution for nickel metal hydride or the like, for example, an aqueous solution obtained using a single kind of or the combination of two or more kinds of electrolytes such as potassium hydroxide and sodium hydroxide may be used.

As an electrolyte solution in the electric double layer capacitor, an arbitrary one may be used. Employable is a non-aqueous electrolyte solution obtained by dissolving a single kind of or two or more kinds of electrolytes in an organic solvent, the electrolytes being for example tetraethylammonium tetrafluoroborate and triethylmonomethylammonium tetrafluoroborate.

In the non-aqueous secondary battery and the electric double layer capacitor, examples of the organic solvent in the non-aqueous electrolyte solution include propylene carbonate, ethylene carbonate, γ-butyrolactone, dimethyl sulfoxide, dimethyl carbonate, ethyl methyl carbonate, diethyl carbonate, 1,2-dimethoxyethane, 1,2-diethoxyethane and tetrahydrofuran. Any of these may be used singly or used in combination.

An embodiment of the present invention is described with reference to the drawing.

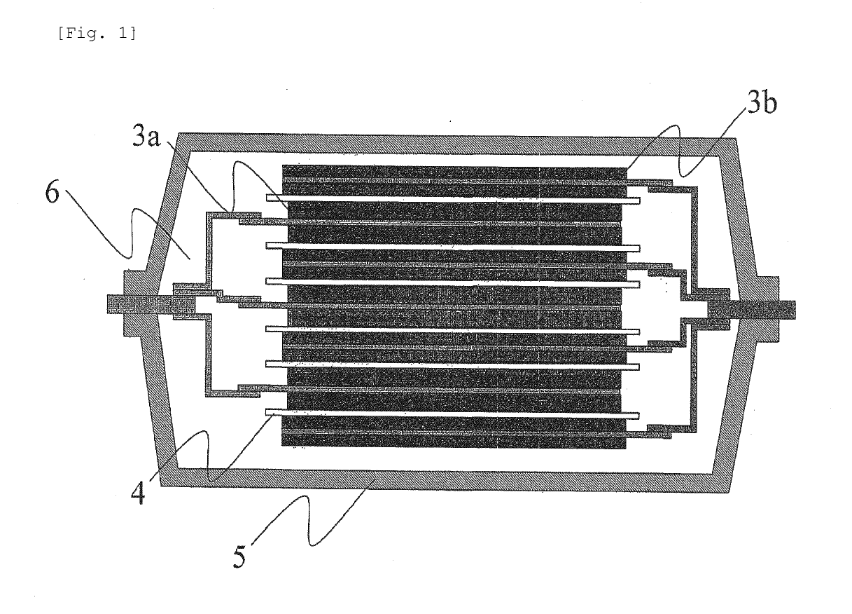

FIG. 1 is a schematic sectional view of a non-aqueous electrolyte secondary battery, which is one of the embodiments of the present invention. The non-aqueous electrolyte secondary battery comprises:

a positive electrode plate 3a and a negative electrode plate 3b each being obtained by applying an aqueous paste for an electrochemical cell obtained by mixing an aqueous dispersion for an electrochemical cell, an active material, a conductive assistant, a thickening agent (viscosity modifier) and the like (not shown in the drawing) with one another, to a rolled metal foil, a porous metal plate or a three-dimensionally shaped metal porous substance having sponge shape or the like;

a separator 4 provided between the positive electrode plate 3a and the negative electrode plate 3b in order to avoid the positive electrode plate 3a and the negative electrode plate 3b directly contacting with each other resulting in short-circuiting;

an outer package material 5 for covering the electrode plate 3a, the electrode plate 3b and the separator 4; and

a non-aqueous electrolyte 6 in which an electrolyte salt such as lithium phosphate hexafluoride (LiPF₆) (not shown in the drawing) is dissolved.

When such a non-aqueous electrolyte secondary battery is charged, lithium ions are drawn from the positive electrode and transfer to the negative electrode. When the non-aqueous electrolyte secondary battery is discharged, lithium ions are drawn from the negative electrode and return to the positive electrode. In other words, charging and discharging operation is based on the transfer of lithium ions between the positive electrode and the negative electrode.

The lithium-ion secondary battery structured as in FIG. 1 is described in detail hereinafter.

First of all, in the use of such a non-aqueous electrolyte secondary battery for a system requiring large capacity such as a household distributed generation system and a storage system, e.g., solar photovoltaic power generation system, in order to obtain large capacity, the preparation of an assembled battery is necessary. However, the use of a small-sized non-aqueous electrolyte secondary battery having small charge-discharge capacity as a single battery leads to the need for hundreds to thousands of such single batteries, which greatly complicates the maintenance of the storage system. For this reason, it is necessary to use a middle-sized or large-sized non-aqueous electrolyte secondary battery having large charge-discharge capacity in which the single battery preferably has a charge-discharge capacity of not less than 5 Ah.

At this time, if the electricity capacity per 1 cm² of the positive electrode plate 3a and of the negative electrode plate 3b is less than 0.5 mAh, more than a dozen to dozens of the plates need be laminated per a single battery, which complicates the production operation of the single battery. For this reason, the electricity capacity per 1 cm² of the positive electrode plate 3a and of the negative electrode plate 3b is 0.5 mAh or more. If the electricity capacity per 1 cm² of the positive electrode plate 3a and of the negative electrode plate 3b is more than 18 mAh, a resistance value due to the thickness of the electrode plates is too high, and input/output properties of the battery is deteriorated, and therefore this is not preferred. The structure of the non-aqueous electrolyte secondary battery having such charge-discharge capacity is described hereinafter.

### (Positive Electrode Plate and Negative Electrode Plate)

A positive electrode plate and a negative electrode plate having a thickness of 5 mm or more do not allow an electrolyte solution to sufficiently permeate therethrough, leading to the difficulty in maintaining the performance. In the case of an electrode having a thickness of less than 0.1 mm, hundreds of the electrode plates need be laminated per a single battery, which complicates the production of the single battery. In view of this, in the embodiments of the present invention, the thickness of the positive electrode plate and the negative electrode plate is 0.1 mm to less than 5 mm, though depending on density of the active materials, types of the aqueous dispersion, the active material, the conductive assistant and the thickening agent to be mixed, electrode-pressing pressure and the like.

With regard to the thickness of the positive electrode plate and the negative electrode plate used in the embodiments of the present invention, when either of the electrodes is prepared as a thick electrode, it is preferable that the positive electrode is thickened. This is in view of the system of a non-aqueous electrolyte secondary battery in which the negative electrode is charged and discharged at a potential close to that of a lithium metal, whereby the increase in the polarization of the negative electrode may cause the precipitation of lithium.

Preferable examples of the positive electrode active material used in the embodiments of the present invention include LiCoO₂; so-called ternary material, Li(Ni—Mn—Co)O₂; NCA-based material, Li(Ni—Co—Al)O₂; LiMn₂O₄; and olivine LiFePO₄.

On the other hand, LiCoO₂, with temperature increase, releases oxygen, leading to combustion of an electrolyte solution involving intense heat generation. In addition, LiCoO₂, containing cobalt (Co), has a problem that Co reserve is less than that of iron (Fe) and Mn (manganese). For these reasons, in recent years, attentions has been focused on olivine LiFePO₄, mainly containing iron, as a positive electrode material having low environment load and involving extremely low cost. This LiFePO₄ achieves high potential and energy density and high safety and stability, as well as has low environment load because of containing iron as a main component. LiFePO₄, in which all of the oxygens are bonded by solid covalent bond with phosphorus, does not involve heat generation as seen with regard to the above-described other positive electrode materials such as LiCoO₂, and is least likely to cause oxygen release induced by temperature increase, and therefore this is preferred in terms of safety. However, LiFePO₄ has lower electron conductivity as compared with other positive electrode active materials, and takes the form of fine particles to compensate for this feature; for this reason, the conventional aqueous dispersion involves difficulty in preparing a slurry to be applied on an electrode plate, leading to the difficulty in preparing a thick electrode. However, as a result of using the aqueous paste of the present invention, the particles of LiFePO₄ and the conductive assistant are homogenously dispersed with the olefin copolymer (a), and good glueability with the electrodes is obtained, and therefore a thick electrode can be easily obtained. Therefore, in the present invention, even when LiFePO₄ is used as the active material, an unconventional secondary battery having small size and high capacity can be obtained at a lower cost.

The positive electrode active material has a particle size distribution preferably such that it has a median diameter (D50), as measured by laser diffraction scattering method, of 0.5 to 9 μm. In the case of D50 being less than 0.5 μm, the preparation of the aqueous paste for an electrochemical cell easily involves the reagglomeration of the particles, which makes it difficult to prepare the electrode plates, and therefore this is not preferred. In the case of D50 being more than 9 μm, the electron conductivity of the particles themselves cannot be obtained easily, which deteriorates input/output performance of the non-aqueous electrolyte secondary battery, and therefore this is not preferred.

The positive electrode active material preferably has a BET specific surface area of 5 to 30 m²/g. A positive electrode active material having a BET specific surface area of less than 5 m²/g has decreased effective area contacting with the conductive assistant and the collector, increases resistance values of the electrode plates, and deteriorates input/output performance of the non-aqueous electrolyte secondary battery, and therefore this is not preferred. A positive electrode active material having a BET specific surface area of more than 30 m²/g increases adsorption amount of a solvent on the particles, and decreases a solid content concentration of the paste in the preparation of the aqueous paste for an electrochemical cell, causing cracking on the surface of the electrode plates dried, and therefore this is not preferred.

With regard to the positive electrode active material used in the embodiments of the present invention, in order for the particles themselves to have increased electron conductivity, the surfaces of the particles may be coated with electron conductive materials such as carbon materials.

As the negative electrode active material used in the embodiments of the present invention, preferable examples are graphite material powder such as spherical natural graphite and artificial graphite, hardly-graphitizable carbon material powder and hard carbon. In terms of improving energy density of the non-aqueous electrolyte secondary battery, graphite material powder is preferable, which provides high voltage. More preferable is spherical natural graphite powder, which is advantageous in terms of cost. The spherical natural graphite can be identified through form observation using a scanning electron microscope (SEM) or the like. Carbon materials for the conductive assistant may be arbitrarily used.

The negative electrode active material has a particle size distribution preferably such that it has a median diameter (D50), as measured by laser diffraction scattering method, of 15 to 20 μm. In the case of D50 being less than 15 μm, the preparation of the aqueous paste for an electrochemical cell easily involves the reagglomeration of the particles, which makes it difficult to prepare the electrode plates, and therefore this is not preferred. In the case of D50 being more than 20 μm, kneading in the preparation of the paste for an electrochemical cell involves the difficulty in the applying of shearing force, which makes it difficult to disperse the particles, and therefore this is not preferred.

The negative electrode active material preferably has a specific surface area (BET) of 2 to 5 m²/g. A negative electrode active material having a specific surface area of less than 2 m²/g has decreased effective area contacting with the conductive assistant and the collector, increases resistance values of the electrode plates, and deteriorates input/output performance of the non-aqueous electrolyte secondary battery, and therefore this is not preferred. A negative electrode active material having a specific surface area of more than 5 m²/g has increased area contacting with the non-aqueous electrolyte, and increases decomposition reaction of the non-aqueous electrolyte in charging, and therefore this is not preferred.

As the conductive assistant used in the embodiments of the present invention, preferable examples include high electron conductive materials such as acetylene black, ketjen black, VGCF, artificial graphite, natural graphite, metal powder, metal fibers and conductive polymers. In terms of improving energy density of the non-aqueous electrolyte secondary battery, artificial graphite material powder is preferred, which has high bulk density. In terms of cost, acetylene black is advantageous. These materials may be used singly, or may be mixed and used. Carbon materials for the negative electrode active material may be arbitrarily used.

The conductive assistant has a particle size distribution preferably such that it has a median diameter (D50), as measured by laser diffraction scattering method, of 0.02 to 80 μm, more preferably 0.4 to 20 μm. In the case of D50 being less than 0.02 μm, the preparation of the aqueous paste for an electrochemical cell easily involves the reagglomeration of the particles, which may make it difficult to prepare the electrode plates. In the case of D50 being more than 80 μm, kneading in the preparation of the paste for an electrochemical cell involves the difficulty in the applying of shearing force, which may make it difficult to disperse the particles. In particular, the conductive assistant used for the negative electrode is preferably, for example, a high electron conductive material in which crystals of primary particles having graphite structure has developed, such as artificial graphite. The conductive assistant used for the positive electrode is preferably acetylene black. The conductive assistant, when being artificial graphite used for the negative electrode, preferably has a median diameter (D50) of 2 to 80 μm, more preferably 4 to 20 μm, in terms of the balance with the median diameter of the negative electrode active material. The conductive assistant, when being acetylene black used for the positive electrode, preferably has a median diameter (D50) of 0.02 to 5 μm, more preferably 0.4 to 3 μm, in terms of the balance with the median diameter of the positive electrode active material.

The conductive assistant preferably has a specific surface area (BET) of 2 to 80 m²/g. A conductive assistant having a specific surface area of less than 2 m²/g has decreased effective area contacting with the active material and the collector, increases resistance values of the electrode plates, and deteriorates input/output performance of the non-aqueous electrolyte secondary battery, and therefore this is not preferred. A conductive assistant having a specific surface area of more than 80 m²/g has increased area contacting with the non-aqueous electrolyte and increases decomposition reaction of the non-aqueous electrolyte in charging, and therefore this is not preferred.

The olefin copolymer (a) used in the aqueous paste for an electrochemical cell of the embodiments of the present invention is preferably the combination of an olefin copolymer (a) having a low melting point of not higher than 120° C., which can alleviate shrinkage stress occurring when drying the fine particulate active material applied, and a surfactant, which is used to well disperse the fine particulate active material in water. The olefin copolymer (a) is preferably an aqueous dispersion comprising the above-described olefin polymer. The surfactant is preferably at least one surfactant selected from potassium oleate, polyoxyethylene ether of acetylenic glycol derivatives and silicon modified polyoxyethylene ether.

The thickening agent used in the aqueous paste for an electrochemical cell of the embodiments of the present invention is not particularly limited. Examples thereof include cellulose derivatives such as carboxymethyl cellulose (CMC), carboxyethyl cellulose and hydroxyethyl cellulose; polyoxyethylene or modified products thereof; polyvinyl alcohol or modified products thereof; and polysaccharide.

Of these viscosity modifiers, CMC, polyoxyethylene or modified products thereof, polyvinyl alcohol or modified products thereof are preferable in terms of settling stability.

As a collector used in the embodiments of the present invention, employable examples include a rolled metal foil, a porous metal plate and a three-dimensionally shaped metal porous substance having lath shape, a punching metal, net shape, sponge shape or the like. In particular, for the positive electrode plate, materials having high oxidation resistance such as Al and Ti are preferable. For the negative electrode plate, materials that hardly form an alloy with lithium, such as Cu, Ni and SUS, are preferable.

The positive electrode plate and the negative electrode plate in the embodiments of the present invention are obtained by applying the above aqueous paste for an electrochemical cell on the above collector. The thickness of the coating film can be controlled using an applicator, a bar coater, a comma coater, a die coater or the like. The positive electrode plate and the negative electrode plate can be pressed before used. It is preferred that the positive electrode plate is pressed such that the packing density of the active material applied is 1.0 to 2.0 g/cm³ and the amount of the active material applied is 4 to 90 mg/cm². It is preferred that the negative electrode plate is preferred such that the packing density of the active material applied is 1.0 to 1.7 g/cm³ and the amount of the active material applied is 2 to 50 mg/cm².

A positive electrode plate and a negative electrode plate having an active material-packing density of lower than 1.0 g/cm³ decrease energy density of the battery, and thus are not preferred.

A positive electrode plate having an active material-packing density of higher than 2.0 g/cm³ decreases permeability of an electrolyte solution into the positive electrode plate, and deteriorates battery performance, and therefore this is not preferred. A negative electrode plate having an active material-packing density of higher than 1.7 g/cm³ allows lithium to be easily precipitated on the negative electrode plate in charging, and deteriorates battery performance, and therefore this is not preferred.

### (Flexure Test of Electrode Plate)

In general, on an industrial scale, a step of applying an electrode material paste on a metal foil is performed using a continuous-coating machine on a roll-to-roll basis, thus requiring electrode plates to go through a supporting bar that supports the electrode plates. In view of this, in the present invention, by the evaluation method described below, a flexure test of the electrode was carried out, and the electrode plate was visually observed to see peeling and cracking.

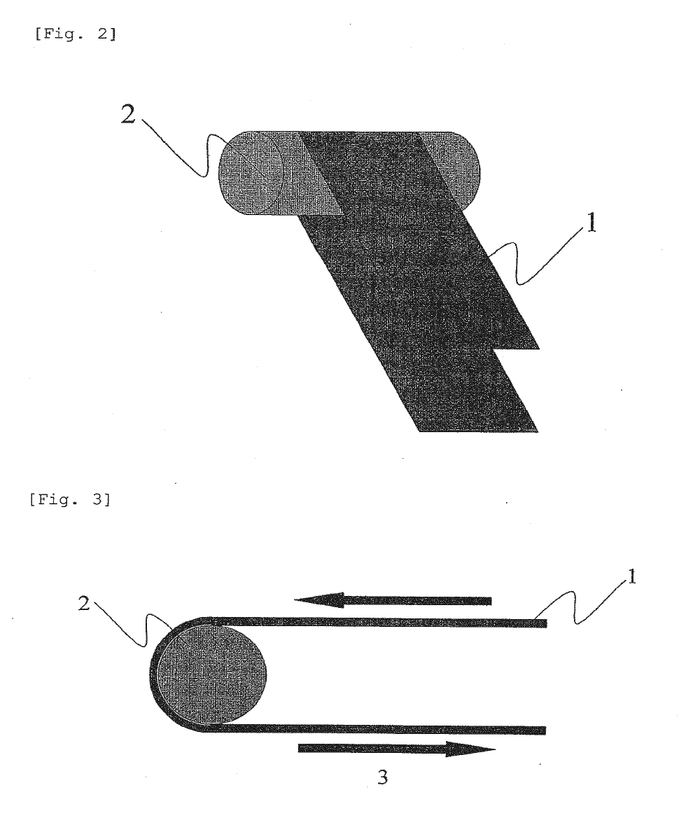

Specifically, as shown in FIGS. 2 and 3, with regard to a positive electrode plate (1), a positive electrode plate (3), a negative electrode plate (2) and a negative electrode plate (4), one side of each plate was wound around a SUS tube having a diameter of 50 mm. Then, the other side of each plate was wound in the same manner. Thereafter, the electrode material on the surface of the electrode plate was visually observed to see peeling and cracking.

### (Non-Aqueous Electrolyte)

Examples of a solvent employable with the non-aqueous electrolyte used in the embodiments of the present invention include:

cyclic carbonates such as propylene carbonate (PC), ethylene carbonate (EC) and butylene carbonate;

linear carbonates such as dimethyl carbonate (DMC), diethyl carbonate (DEC), ethyl methyl carbonate and dipropyl carbonate;

lactones such as γ-butyrolactone and γ-valerolactone;

furans such as tetrahydrofuran and 2-methyl

tetrahydrofuran;

ethers such as diethyl ether, 1,2-dimethoxyethane,

1,2-diethoxyethane, ethoxy methoxy ethane and dioxane; and

dimethyl sulfoxide, sulfolane, methyl sulfolane, acetonitrile, methyl formate and methyl acetate. A mixture of more than one kind of these may be used. In particular, cyclic carbonates such as PC, EC and butylene carbonate are preferable, which are solvents having high boiling point.

Examples of an electrolyte salt employable for the non-aqueous electrolyte used in the embodiments of the present invention include lithium salts such as lithium borofluoride (LiBF₄), lithium phosphate hexafluoride (LiPF₆), lithium trifluoromethane sulfonate (LiCF₃SO₃), lithium trifluoroacetate (LiCF₃COO) and lithium bis(trifluoromethane sulfone)imide (LiN(CF₃SO₂)₂). A mixture of more than one kind of these may be used.

The concentration of the above non-aqueous electrolyte salt of lower than 0.5 mol/L decreases carrier concentration in the electrolyte solution, consequently increasing resistance of the non-aqueous electrolyte. The concentration of the non-aqueous electrolyte salt of higher than 3 mol/L decreases dissociation degree of the salt itself, failing to increase carrier concentration in the non-aqueous electrolyte solution 6. In view of the above, the concentration of the non-aqueous electrolyte salt in the embodiments of the present invention is 0.5 to 3 mol/L.

### (Separator)

The separator used in the embodiments of the present invention is selectable from nonwoven fabrics and microporous films composed of e.g., polyethylene, polypropylene and polyester.

With regard to the above separator, a separator having voids of lower than 30% decreases the content of the non-aqueous electrolyte, increases internal resistance of the non-aqueous electrolyte secondary battery. A separator having voids of higher than 90% allows the positive electrode plate and the negative electrode plate to physically contact with each other, and this causes internal short-circuiting of the non-aqueous electrolyte secondary battery. A separator having a thickness of less than 5 μm is a separator with insufficient mechanical strength, which causes internal short-circuiting of the non-aqueous electrolyte secondary battery. A separator having a thickness of more than 100 μm increases a distance between the positive electrode and the negative electrode, increasing internal resistance of the non-aqueous electrolyte secondary battery. In view of this, in the embodiments of the present invention, the separator has voids of 30% to 90% and has a thickness of 5 μm to 100 μm.

### (Outer Package Material)

The outer package material for the non-aqueous electrolyte secondary battery used in the embodiments of the present invention is preferably a metal can: for example, a can made of iron, stainless steel, aluminum or the like. A film-shaped bag obtained by having aluminum with an extremely small thickness laminated with resins may be used. The shape of the outer package material may be any of cylindrical shape, square shape and thin shape, but in view of many opportunities using a large-sized lithium-ion secondary battery as an assembled battery, the outer package material having square shape or thin shape is preferable.

### EXAMPLES

The present invention is specifically described hereinafter with reference to Examples and Comparative Examples, but the present invention is not limited to these examples.

### Preparation of Emulsion Composition

### Example 1

An olefin copolymer (a) was prepared by mixing 100 parts by weight of a maleic-modified random polypropylene (a-2) having a weight average molecular weight of 100,000 (in terms of polystyrene) and a maleic-modification degree of 1.0 and containing a total of 25% by weight of butene as a copolymerization component with 30 parts by weight of a maleic-modified polypropylene (a-4) having a weight average molecular weight of 20,000 and a maleic-modification degree of 4. The resultant was further mixed with 10 parts of potassium oleate. The resultant mixture was melt kneaded with a biaxial extruder at 200° C., which is followed by kneading while adding a potassium hydroxide aqueous solution.

The product discharged was dispersed in water, to thereby give an emulsion (aqueous dispersion for an electrochemical cell (A)) comprising an olefin copolymer (a) having a volume average particle diameter of 200 nm and a nonvolatile content of 45%. The melting point of the (a) was 85° C.

### Example 2

Preparation was performed in the same manner as in Example 1, except that as an olefin copolymer (a), 100 parts by weight of the modified random polypropylene (a-2) was replaced with 20 parts by weight of a random polypropylene (a-1) having a weight average molecular weight of 100,000 and containing 30% by weight of ethylene and butene as a copolymerization component, and 80 parts by weight of a maleic-modified random polypropylene (a-2) having a maleic-modification degree of 1.0 and containing a total of 25% by weight of butene as a copolymerization component, to thereby give an emulsion comprising an olefin copolymer (a) having a volume average particle diameter of 200 nm and a nonvolatile content of 45%. The melting point of the (a) was 80° C.

### Example 3

Preparation was performed in the same manner as in Example 1, except that as an olefin copolymer (a), the modified random polypropylene (a-2) was replaced with a random polypropylene (a-1) having a weight average molecular weight of 100,000 and containing 30% by weight of ethylene and butene as a copolymerization component, to thereby give an emulsion comprising an olefin copolymer (a) having a volume average particle diameter of 350 nm and a nonvolatile content of 45%. The melting point of the (a) was not detected.

### Example 4

Preparation was performed in the same manner as in Example 3, except that as an olefin copolymer (a), the random polypropylene (a-1) of Example 3 was replaced with a random propylene (a-1) containing 30% by weight of butene as a copolymerization component, to thereby give an emulsion comprising an olefin copolymer (a) having a volume average particle diameter of 300 nm and a nonvolatile content of 45%. The melting point of the (a) was 80° C.

### Example 5

Preparation was performed in the same manner as in Example 3, except that as an olefin copolymer (a), the random polypropylene (a-1) of Example 3 was replaced with a random propylene (a-1) containing 40% by weight of ethylene as a copolymerization component, to thereby give an emulsion comprising an olefin copolymer (a) having a volume average particle diameter of 350 nm and a nonvolatile content of 45%. The melting point of the (a) was 85° C.

### Example 6

Preparation was performed in the same manner as in Example 1, except that as an olefin copolymer (a), the modified random polypropylene (a-2) was replaced with a maleic-modified random polypropylene (a-2) having a weight average molecular weight of 60,000 and a maleic-modification degree of 1.0 and containing 40% by weight of ethylene as a copolymerization component, to thereby give an emulsion comprising an olefin copolymer (a) having a volume average particle diameter of 200 nm and a nonvolatile content of 45%. The melting point of the (a) was 80° C.

### Example 7

Preparation was performed in the same manner as in Example 1, except that as an olefin copolymer (a), the modified random polypropylene (a-2) was replaced with a maleic-modified random polypropylene (a-2) having a weight average molecular weight of 60,000 and a maleic-modification degree of 1.0 and containing 30% by weight of ethylene and butene as a copolymerization component, to thereby give an emulsion comprising an olefin copolymer (a) having a volume average particle diameter of 200 nm and a nonvolatile content of 45%. The melting point of the (a) was not detected.

### Example 8

Preparation was performed in the same manner as in Example 1, except that as an olefin copolymer (a), 100 parts by weight of the modified random polypropylene (a-2) was replaced with 95 parts by weight of a maleic-modified random polypropylene (a-2) having a weight average molecular weight of 100,000 and a maleic-modification degree of 1.0 and containing a total of 25% by weight of butene as a copolymerization component, and 5 parts by weight of an ethylene-methacrylic acid copolymer (content of methacrylic acid: 4% by weight) (a-3) having a weight average molecular weight of 90,000, to thereby give an emulsion comprising an olefin copolymer (a) having a volume average particle diameter of 200 nm and a nonvolatile content of 45%. The melting point of the (a) was 80° C.

### Example 9

Preparation was performed in the same manner as in Example 1, except that as an olefin copolymer (a), the modified random polypropylene (a-2) was replaced with a maleic-modified random polypropylene (a-2) having a weight average molecular weight of 70,000 and a maleic-modification degree of 1.0 and containing a total of 30% by weight of butene as a copolymerization component, to thereby give an emulsion comprising an olefin copolymer (a) having a volume average particle diameter of 250 nm and a nonvolatile content of 45%. The melting point of the (a) was 80° C.

### Example 10

Preparation was performed in the same manner as in Example 1, except that the modified polypropylene (a-4) was blended in an amount of 20 parts by weight, and potassium oleate was blended in an amount of 10 parts by weight, to thereby give an emulsion comprising an olefin copolymer (a) having a volume average particle diameter of 250 nm and a nonvolatile content of 45%. The melting point of the (a) was 80° C.

### Example 11

Preparation was performed in the same manner as in Example 1, except that the modified polypropylene (a-4) was blended in an amount of 10 parts by weight, and potassium oleate was blended in an amount of 4 parts by weight, to thereby give an emulsion comprising an olefin copolymer (a) having a volume average particle diameter of 300 nm and a nonvolatile content of 45%. The melting point of the (a) was 80° C.

### Example 12

Preparation was performed in the same manner as in Example 1, except that the modified polypropylene (a-4) was blended in an amount of 50 parts by weight, and potassium oleate was blended in an amount of 15 parts by weight, to thereby give an emulsion comprising an olefin copolymer (a) having a volume average particle diameter of 260 nm and a nonvolatile content of 45%. The melting point of the (a) was 80° C.

### Comparative Example 1

Instead of the olefin copolymer (a), an emulsion containing styrene butadiene rubber (SBR, SR143 manufactured by NIPPON A&L INC., volume average particle diameter: 160 nm, solid content concentration: 48% by weight) was used as it was.

### Comparative Example 2

Preparation was performed in the same manner as in Example 1, except that the modified random polypropylene (a-2) was replaced with a maleic-modified random polypropylene having a weight average molecular weight of 100,000 and a maleic-modification degree of 1.0 and containing a total of 5% by weight of ethylene and butene as a copolymerization component, to thereby give an emulsion having a volume average particle diameter of 300 nm and a nonvolatile content of 45%. The melting point of the emulsion was 140° C.

### Comparative Example 3

Preparation was performed in the same manner as in Example 1, except that the modified random polypropylene (a-2) was replaced with a maleic-modified random polypropylene having a weight average molecular weight of 60,000 and a maleic-modification degree of 1.5 and containing a total of 5% by weight of ethylene and butene as a copolymerization component, to thereby give an emulsion having a volume average particle diameter of 200 nm and a nonvolatile content of 45%. The melting point of the emulsion was 135° C.

### Comparative Example 4

Preparation was performed in the same manner as in Example 1, except that the olefin copolymer (a) was replaced with 100 parts by weight of a maleic-modified random polypropylene having a weight average molecular weight of 100,000 and a maleic-modification degree of 0.7 and containing a total of 5% by weight of ethylene and butene as a copolymerization component, the modified polypropylene (a-4) was blended in an amount of 20 parts by weight, and potassium oleate was blended in an amount of 6 parts by weight, to thereby give an emulsion having a volume average particle diameter of 300 nm and a nonvolatile content of 45%. The melting point of the emulsion was 140° C.

### Comparative Example 5

Preparation was performed in the same manner as in Comparative Example 4, except that the olefin copolymer (a) was replaced with a maleic-modified random polypropylene having a weight average molecular weight of 60,000 and a maleic-modification degree of 1.5 and containing a total of 5% by weight of ethylene and butene as a copolymerization component, to thereby give an emulsion having a volume average particle diameter of 200 nm and a nonvolatile content of 45%. The melting point of the emulsion was 135° C.

### Comparative Example 6

Preparation was performed in the same manner as in Comparative Example 4, except that the olefin copolymer (a) was replaced with 100 parts by weight of a maleic-modified random polypropylene having a weight average molecular weight of 100,000 and a maleic-modification degree of 0.7 and containing a total of 10% by weight of ethylene and butene as a copolymerization component, to thereby give an emulsion having a volume average particle diameter of 200 nm and a nonvolatile content of 45%. The melting point of the emulsion was 135° C.

### <Swell of Resin in Electrolyte Solution>

The emulsion of Examples 1 to 12 or Comparative Examples 1 to 6 was applied on a glass plate, and dried at 120° C. for 3 hours, to thereby give a film. The film was immersed in a solution of ethylene carbonate (EC)/methylethyl carbonate (MEC)=1/1 (vol/vol) at 80° C. for 3 days, and a weight of the film swollen was measured. A weight ratio of the weight of the film swollen to a weight of the film before swollen was calculated. Similarly, a weight ratio in the case of the immersion solution being a potassium hydroxide (KOH) aqueous solution (20° C.) was calculated.

Results are set forth in Table 1.

TABLE 1

| | | Ratio of swell in |
|---|---|---|
| | Ratio of swell in EC/EMC | KOH aqueous solution |
| Ex. 1 | 1.1 | 1.1 |
| Ex. 2 | 1.1 | 1.1 |
| Ex. 3 | 1.1 | 1.1 |
| Ex. 4 | 1.1 | 1.1 |
| Ex. 5 | 1.1 | 1.1 |
| Ex. 6 | 1.1 | 1.1 |
| Ex. 7 | 1.1 | 1.1 |
| Ex. 8 | 1.1 | 1.1 |
| Ex. 9 | 1.1 | 1.1 |
| Ex. 10 | 1.1 | 1.1 |
| Ex. 11 | 1.1 | 1.1 |
| Ex. 12 | 1.1 | 1.1 |
| Comp. Ex. 1 | 2.5 | 2.0 |
| Comp. Ex. 2 | 1.1 | 1.1 |
| Comp. Ex. 3 | 1.1 | 1.1 |
| Comp. Ex. 4 | 1.1 | 1.1 |
| Comp. Ex. 5 | 1.1 | 1.1 |
| Comp. Ex. 6 | 1.1 | 1.1 |

### <Preparation of Lithium Secondary Battery Negative Electrode Plate>

The following components were mixed with one another:

1 part by weight in terms of a solid content of a viscosity modifier (y) prepared so as to have 1.2% by weight selected from carboxymethyl cellulose (Daicel Corporation, CMC 1160, weight average molecular weight: 650,000), hydroxyethyl cellulose (Daicel Corporation, SP600, weight average molecular weight: 1,000,000), polyoxyethylene (Meisei Chemical Works, Ltd., ALKOX E-75, weight average molecular weight: 2,000,000) and polyvinyl alcohol (KURARAY CO., LTD., KL-318, weight average molecular weight: 70,000);

2 parts by weight in terms of a solid content of the emulsion prepared in any of Examples 1 to 8 and Comparative Examples 1 to 3; and

a surfactant (x), as an optional component, selected from an anionic surfactant (manufactured by NOF CORPORATION, NONSAL OK-2), a nonionic surfactant (Nissin Chemical Industry Co., Ltd., OLFINE E1010) and a silicon-based surfactant (Shin-Etsu Chemical Co., Ltd., KF354L). Thereby, an aqueous dispersion (A) of any of Compounding Examples 1A to 13A and Compounding Comparative Examples 1a to 3a was obtained. The composition of the aqueous dispersion (A) is set forth in Table 2.

To 90 parts by weight of natural graphite (active material B) (LF18A manufactured by Chuetsu Graphite Works Co., Ltd.) and 7 parts by weight of acetylene black (conductive assistant C) (Denka Black: manufactured by DENKI KAGAKU KOGYO KABUSHIKI KAISHA), the aqueous dispersion (A) obtained of Compounding Example or Compounding Comparative Example and distilled water were added, to thereby prepare a negative electrode mix slurry (aqueous paste) having a solid content concentration of 50% by weight. The negative electrode mix slurries obtained were named slurry 1A to 13A and slurry 1a to 3a, respectively.

Subsequently, each of these negative electrode mix slurries was applied on a negative electrode collector having a thickness of 18 μm made of a strip-shaped copper foil, and dried and compression molded, to thereby prepare a negative electrode having a thickness of 70 μm.

On the other hand, 90 parts by weight of natural graphite (B) (LF18A) and 7 parts of acetylene black (conductive assistant C) (Denka Black) were mixed with 1 part by weight in terms of a solid content of carboxymethyl cellulose (CMC 1160) prepared so as to have 1.2% by weight. The resultant was mixed with 2 parts by weight in terms of a solid content of the emulsion prepared in any of Examples 1, 8 to 12 and Comparative Examples 4 to 6. To the resultant, distilled water was added, to thereby prepare a negative electrode mix slurry (aqueous paste) having a solid content concentration of 50% by weight. The negative electrode mix slurries obtained were named slurry 14A to 19A and slurry 4a to 6a, respectively.

Subsequently, each of these negative electrode mix slurries was applied on a negative electrode collector having a thickness of 18 μm made of a strip-shaped copper foil, and dried and compression molded, to thereby prepare a negative electrode having a thickness of 70 μm.

TABLE 2

| | Example and | | |
|---|---|---|---|
| | Comparative | Viscosity | |
| Aqueous dispersion (A) | Example | modifier (y) | Surfactant (x) |
| Compounding Ex. 1A | Ex. 1 | carboxymethyl | None |
| | | cellulose | |
| Compounding Ex. 2A | Ex. 1 | polyoxyethylene | None |
| Compounding Ex. 3A | Ex. 1 | polyvinyl alcohol | None |
| Compounding Ex. 4A | Ex. 1 | hydroxyethyl | None |
| | | cellulose | |
| Compounding Ex. 5A | Ex. 2 | polyvinyl alcohol | anionic: 0.5 part |
| | | | by weight |
| Compounding Ex. 6A | Ex. 3 | polyvinyl alcohol | anionic: 0.5 part |
| | | | by weight |
| Compounding Ex. 7A | Ex. 4 | polyvinyl alcohol | anionic: 0.5 part |
| | | | by weight |
| Compounding Ex. 8A | Ex. 1 | polyvinyl alcohol | anionic: 0.5 part |
| | | | by weight |
| | | | nonionic: 0.5 part |
| | | | by weight |
| Compounding Ex. 9A | Ex. 1 | polyvinyl alcohol | anionic: 0.5 part |
| | | | by weight |
| | | | nonionic: 0.5 part |
| | | | by weight |
| | | | silicon-based: |
| | | | 0.5 part by weight |
| Compounding Ex. 10A | Ex. 5 | polyvinyl alcohol | None |
| Compounding Ex. 11A | Ex. 6 | polyvinyl alcohol | None |
| Compounding Ex. 12A | Ex. 7 | polyvinyl alcohol | None |
| Compounding Ex. 13A | Ex. 8 | polyvinyl alcohol | None |
| Compounding Comp. Ex. 1a | Comp. Ex. 1 | carboxymethyl | None |
| | | cellulose | |
| Compounding Comp. Ex. 2a | Comp. Ex. 2 | carboxymethyl | None |
| | | cellulose | |
| Compounding Comp. Ex. 3a | Comp. Ex. 3 | carboxymethyl | None |
| | | cellulose | |

### <Preparation of Lithium Secondary Battery Positive Electrode Plate>

The following components were compounded:

1.5 parts by weight in terms of a solid content of the viscosity modifier (y) used in the preparation of the negative electrode plate;

5 parts by weight in terms of a solid content of the emulsion prepared in any of Examples 1 to 8 and Comparative Examples 1 to 3; and

the surfactant, as an optional component, used in the preparation of the negative electrode plate. Thereby, an aqueous dispersion (A) of any of Compounding Examples 1B to 13B and Compounding Comparative Examples 1b to 3b was obtained. The composition of the aqueous dispersion (A) is set forth in Table 3.

To 85.5 parts by weight of LiCoO₂ (B) (HLC-22 manufactured by Honjo FMC Energy Systems Inc.), 8 parts by weight of artificial graphite (conductive assistant C) and 3 parts by weight of acetylene black (conductive assistant C) (Denka Black), the aqueous dispersion (A) obtained of Compounding Example or Compounding Comparative Example and distilled water were added, to thereby prepare a LiCoO₂ mix slurry (aqueous paste) having a solid content concentration of 50% by weight. The mix slurries obtained were named slurry 1B to 13B and slurry 1b to 3b, respectively.

Each of these LiCoO₂ mix slurries was applied on an aluminum foil having a thickness of 20 μm, and dried and compression molded, to thereby prepare a positive electrode having a thickness of 70 μm.

On the other hand, to 85.5 parts by weight of LiCoO₂ (B) (HLC-22), 8 parts by weight of artificial graphite (C), 3 parts by weight of acetylene black (C) (Denka Black) and 1.5 parts by weight in terms of a solid content of carboxymethyl cellulose (CMC 1160) prepared so as to have 1.2% by weight, 2 parts by weight in terms of a solid content of the emulsion prepared in any of Examples 1, 8 to 12 and Comparative Examples 4 to 6 was added, and further distilled water was added, to thereby prepare a LiCoO₂ mix slurry (aqueous paste) having a solid content concentration of 50% by weight. The mix slurries obtained were named slurry 14B to 19B and slurry 4b to 6b, respectively.

Each of these LiCoO₂ mix slurries was applied on an aluminum foil having a thickness of 20 μm, and dried and compression molded, to thereby prepare a positive electrode having a thickness of 70 μm.

TABLE 3

| | Example and | | |
|---|---|---|---|
| Aqueous | Comparative | Viscosity | |
| dispersion (A) | Example | modifier (y) | Surfactant (x) |
| Compounding Ex. 1B | Ex. 1 | carboxymethyl | None |
| | | cellulose | |
| Compounding Ex. 2B | Ex. 1 | Polyoxyethylene | None |
| Compounding Ex. 3B | Ex. 1 | polyvinyl alcohol | None |
| Compounding Ex. 4B | Ex. 1 | hydroxyethyl | None |
| | | cellulose | |
| Compounding Ex. 5B | Ex. 2 | polyvinyl alcohol | anionic: |
| | | | 0.5 part |
| | | | by weight |
| Compounding Ex. 6B | Ex. 3 | polyvinyl alcohol | anionic: |
| | | | 0.5 part |
| | | | by weight |
| Compounding Ex. 7B | Ex. 4 | polyvinyl alcohol | anionic: |
| | | | 0.5 part |
| | | | by weight |
| Compounding Ex. 8B | Ex. 1 | polyvinyl alcohol | anionic: |
| | | | 0.5 part |
| | | | by weight |
| | | | nonionic: |
| | | | 0.5 part |
| | | | by weight |
| Compounding Ex. 9B | Ex. 1 | polyvinyl alcohol | anionic: |
| | | | 0.5 part |
| | | | by weight |
| | | | nonionic: |
| | | | 0.5 part |
| | | | by weight |
| | | | silicon-based: |
| | | | 0.5 part |
| | | | by weight |
| Compounding Ex. 10B | Ex. 5 | polyvinyl alcohol | None |
| Compounding Ex. 11B | Ex. 6 | polyvinyl alcohol | None |
| Compounding Ex. 12B | Ex. 7 | polyvinyl alcohol | None |
| Compounding Ex. 13B | Ex. 8 | polyvinyl alcohol | None |
| Compounding | Comp. Ex. 1 | carboxymethyl | None |
| Comp. Ex. 1b | | cellulose | |
| Compounding | Comp. Ex. 2 | carboxymethyl | None |
| Comp. Ex. 2b | | cellulose | |
| Compounding | Comp. Ex. 3 | carboxymethyl | None |
| Comp. Ex. 3b | | cellulose | |

### <Adhesion Evaluation of Lithium Secondary Battery>

The electrode prepared above was cut and attached with an instantaneous adhesive on a glass preparation in order for the electrode to be fixed, to thereby prepare a sample for evaluation. The sample for evaluation was cut with an apparatus for measuring peeling strength of coating films, SAICAS DN20, (manufactured by DAIPLA WINTES CO., LTD.) at an interface between the mix layer and the collector at a horizontal rate of 2 μm/sec. From a force in the horizontal direction necessary for the cutting, a peeling strength at the interface between the mix layer and the collector was measured. An average value of peeling strength values measured three times was calculated to evaluate adhesion. The mix layer refers to a coated part obtained by applying the aqueous paste on an aluminum foil or a copper foil (collector) and drying and pressing the aqueous paste.

Results are set forth in Tables 4 and 5.

TABLE 4

| | | Peeling strength |
|---|---|---|
| Electrode | Aqueous dispersion (A) | (kN/m) |
| Negative electrode | Compounding Ex. 1A | 0.39 |
| Negative electrode | Compounding Ex. 2A | 0.41 |
| Negative electrode | Compounding Ex. 3A | 0.40 |
| Negative electrode | Compounding Ex. 4A | 0.39 |
| Negative electrode | Compounding Ex. 5A | 0.39 |
| Negative electrode | Compounding Ex. 6A | 0.39 |
| Negative electrode | Compounding Ex. 7A | 0.40 |
| Negative electrode | Compounding Ex. 8A | 0.37 |
| Negative electrode | Compounding Ex. 9A | 0.39 |
| Negative electrode | Compounding Ex. 10A | 0.39 |
| Negative electrode | Compounding Ex. 11A | 0.37 |
| Negative electrode | Compounding Ex. 12A | 0.39 |
| Negative electrode | Compounding Ex. 13A | 0.38 |
| Negative electrode | Compounding Comp. Ex. 1a | 0.34 |
| Negative electrode | Compounding Comp. Ex. 2a | 0.35 |
| Negative electrode | Compounding Comp. Ex. 3a | 0.38 |
| Positive electrode | Compounding Ex. 1B | 0.38 |
| Positive electrode | Compounding Ex. 2B | 0.39 |
| Positive electrode | Compounding Ex. 3B | 0.39 |
| Positive electrode | Compounding Ex. 4B | 0.38 |
| Positive electrode | Compounding Ex. 5B | 0.38 |
| Positive electrode | Compounding Ex. 6B | 0.39 |
| Positive electrode | Compounding Ex. 7B | 0.38 |
| Positive electrode | Compounding Ex. 8B | 0.38 |
| Positive electrode | Compounding Ex. 9B | 0.38 |
| Positive electrode | Compounding Ex. 10B | 0.39 |
| Positive electrode | Compounding Ex. 11B | 0.38 |
| Positive electrode | Compounding Ex. 12B | 0.38 |
| Positive electrode | Compounding Ex. 13B | 0.39 |
| Positive electrode | Compounding Comp. Ex. 1b | 0.25 |
| Positive electrode | Compounding Comp. Ex. 2b | 0.33 |
| Positive electrode | Compounding Comp. Ex. 3b | 0.37 |

TABLE 5

| | | Peeling strength |
|---|---|---|
| Electrode | Slurry (Aqueous paste) | (kN/m) |
| Negative electrode | 14A (Ex. 1) | 0.39 |
| Negative electrode | 15A (Ex. 9) | 0.38 |
| Negative electrode | 16A (Ex. 8) | 0.37 |
| Negative electrode | 17A (Ex. 10) | 0.35 |
| Negative electrode | 18A (Ex. 11) | 0.35 |
| Negative electrode | 19A (Ex. 12) | 0.34 |
| Negative electrode | 4a (Comp. Ex. 4) | 0.35 |
| Negative electrode | 5a (Comp. Ex. 5) | 0.38 |
| Negative electrode | 6a (Comp. Ex. 6) | 0.31 |
| Positive electrode | 14B (Ex. 1) | 0.38 |
| Positive electrode | 15B (Ex. 9) | 0.38 |
| Positive electrode | 16B (Ex. 8) | 0.38 |
| Positive electrode | 17B (Ex. 10) | 0.38 |
| Positive electrode | 18B (Ex. 11) | 0.37 |
| Positive electrode | 19B (Ex. 12) | 0.36 |
| Positive electrode | 4b (Comp. Ex. 4) | 0.33 |
| Positive electrode | 5b (Comp. Ex. 5) | 0.37 |
| Positive electrode | 6b (Comp. Ex. 6) | 0.32 |

### <Preparation of Non-Aqueous Electrolyte Solution for Lithium-Ion Secondary Battery>

A non-aqueous solvent was prepared by mixing ethylene carbonate (EC) and methylethyl carbonate (MEC) at a ratio of EC:MEC=4:6 (weight ratio). Then, LiPF₆, an electrolyte, was dissolved in the solvent. A non-aqueous electrolyte solution was prepared so as to have an electrolyte concentration of 1.0 mol/L.

### <Preparation of Coin-Shaped Lithium-Ion Secondary Battery>

As a negative electrode for a coin-shaped battery, from the above negative electrode, a disk having a diameter of 14 mm was stamped out, to thereby give a coin-shaped negative electrode having a weight of 20 mg and a diameter of 14 mm. As a positive electrode for a coin-shaped battery, from the above positive electrode, a disk having a diameter of 13.5 mm was stamped out, to thereby give a coin-shaped positive electrode having a weight of 42 mg and a diameter of 13.5 mm.

The coin-shaped negative electrode and positive electrode, and a separator composed of a microporous polypropylene film having a thickness of 25 μm and a diameter of 16 mm were laminated in the order of the negative electrode, the separator and the positive electrode in a negative electrode can of a 2032-size battery can made of stainless. Then, into the separator, 0.04 mL of the above non-aqueous electrolyte solution was poured. Then, on the laminate, a plate made of aluminum (thickness: 1.2 mm, diameter: 16 mm) and a spring were superposed.

Finally, via a gasket made of polypropylene, a positive electrode can of the battery was placed, and a can lid was caulked in order for the battery to be hermetic therein, to thereby prepare a coin-shaped battery having a diameter of 20 mm and a height of 3.2 mm.

### <Evaluation of Electrode Swell>

The coin-shaped battery was charged with a device of NAGANO LTD. at a constant current of 0.5 mA and at constant voltage of 4.2 V until the current value at a constant voltage of 4.2 V reached 0.05 mA, and then the coin-shaped battery was discharged at a constant current of 1 mA and at a constant voltage of 3.0 V until the current value at a constant voltage of 3.0 V reached 0.05 mA. This cycle was repeated 100 times. Then, a thickness (L1) of the mix layer of the electrode after 100 cycles and a thickness (L2) of the mix layer of the electrode before the pouring of the electrolyte solution were compared with each other.

Results are set forth in Tables 6 and 7, which indicate (L1/L2).

TABLE 6

| Electrode | Aqueous dispersion (A) | Thickness (L1/L2) |
|---|---|---|
| Negative electrode | Compounding Ex. 1A | 1.15 |
| Negative electrode | Compounding Ex. 2A | 1.12 |
| Negative electrode | Compounding Ex. 3A | 1.13 |
| Negative electrode | Compounding Ex. 4A | 1.15 |
| Negative electrode | Compounding Ex. 5A | 1.15 |
| Negative electrode | Compounding Ex. 6A | 1.14 |
| Negative electrode | Compounding Ex. 7A | 1.12 |
| Negative electrode | Compounding Ex. 8A | 1.11 |
| Negative electrode | Compounding Ex. 9A | 1.11 |
| Negative electrode | Compounding Ex. 10A | 1.14 |
| Negative electrode | Compounding Ex. 11A | 1.13 |
| Negative electrode | Compounding Ex. 12A | 1.15 |
| Negative electrode | Compounding Ex. 13A | 1.14 |
| Negative electrode | Compounding Comp. Ex. 1a | 1.60 |
| Negative electrode | Compounding Comp. Ex. 2a | 1.15 |
| Negative electrode | Compounding Comp. Ex. 3a | 1.15 |
| Positive electrode | Compounding Ex. 1B | 1.05 |
| Positive electrode | Compounding Ex. 2B | 1.05 |
| Positive electrode | Compounding Ex. 3B | 1.05 |
| Positive electrode | Compounding Ex. 4B | 1.05 |
| Positive electrode | Compounding Ex. 5B | 1.05 |
| Positive electrode | Compounding Ex. 6B | 1.05 |
| Positive electrode | Compounding Ex. 7B | 1.05 |
| Positive electrode | Compounding Ex. 8B | 1.05 |
| Positive electrode | Compounding Ex. 9B | 1.05 |
| Positive electrode | Compounding Ex. 10B | 1.05 |
| Positive electrode | Compounding Ex. 11B | 1.05 |
| Positive electrode | Compounding Ex. 12B | 1.05 |
| Positive electrode | Compounding Ex. 13B | 1.05 |
| Positive electrode | Compounding Comp. Ex. 1b | Peeling |
| Positive electrode | Compounding Comp. Ex. 2b | 1.05 |
| Positive electrode | Compounding Comp. Ex. 3b | 1.05 |

TABLE 7

| Electrode | Slurry (Aqueous paste) | Thickness (L1/L2) |
|---|---|---|
| Negative electrode | 14A (Ex. 1) | 1.10 |
| Negative electrode | 15A (Ex. 9) | 1.10 |
| Negative electrode | 16A (Ex. 8) | 1.10 |
| Negative electrode | 17A (Ex. 10) | 1.10 |
| Negative electrode | 18A (Ex. 11) | 1.10 |
| Negative electrode | 19A (Ex. 12) | 1.10 |
| Negative electrode | 4a (Comp. Ex. 4) | 1.15 |
| Negative electrode | 5a (Comp. Ex. 5) | 1.15 |
| Negative electrode | 6a (Comp. Ex. 6) | 1.15 |
| Positive electrode | 14B (Ex. 1) | 1.05 |
| Positive electrode | 15B (Ex. 9) | 1.05 |
| Positive electrode | 16B (Ex. 8) | 1.05 |
| Positive electrode | 17B (Ex. 10) | 1.05 |
| Positive electrode | 18B (Ex. 11) | 1.05 |
| Positive electrode | 19B (Ex. 12) | 1.05 |
| Positive electrode | 4b (Comp. Ex. 4) | 1.05 |
| Positive electrode | 5b (Comp. Ex. 5) | 1.05 |
| Positive electrode | 6b (Comp. Ex. 6) | 1.05 |

### <Evaluation of Battery Cycle Property>

In the same evaluation manner as described with regard to the electrode swell, the cycle was repeated 500 times. Then, a capacity (%) after 500 cycles relative to an initial battery capacity was evaluated.

Evaluation results are set forth in Tables 8 and 9.

TABLE 8

| | | | Capacity |
|---|---|---|---|
| Battery | | | after 500 |
| No. | Positive electrode | Negative electrode | cycles (%) |
| 1 | Compounding Ex. 1B | Compounding Ex. 1A | 87 |
| 2 | Compounding Ex. 2B | Compounding Ex. 1A | 85 |
| 3 | Compounding Ex. 3B | Compounding Ex. 1A | 86 |
| 4 | Compounding Ex. 4B | Compounding Ex. 1A | 85 |
| 5 | Compounding Ex. 5B | Compounding Ex. 1A | 84 |
| 6 | Compounding Ex. 6B | Compounding Ex. 1A | 88 |
| 7 | Compounding Ex. 7B | Compounding Ex. 1A | 84 |
| 8 | Compounding Ex. 8B | Compounding Ex. 1A | 86 |
| 9 | Compounding Ex. 9B | Compounding Ex. 1A | 81 |
| 10 | Compounding Ex. 10B | Compounding Ex. 1A | 82 |
| 11 | Compounding Ex. 11B | Compounding Ex. 1A | 84 |
| 12 | Compounding Ex. 12B | Compounding Ex. 1A | 81 |
| 13 | Compounding Ex. 13B | Compounding Ex. 1A | 83 |
| 14 | Compounding Comp. | Compounding Ex. 1A | 45 |
| | Ex. 1b | | |
| 15 | Compounding Comp. | Compounding Ex. 1A | 75 |
| | Ex. 2b | | |
| 16 | Compounding Comp. | Compounding Ex. 1A | 76 |
| | Ex. 3b | | |
| 17 | Compounding Ex. 1B | Compounding Ex. 2A | 80 |
| 18 | Compounding Ex. 1B | Compounding Ex. 3A | 82 |
| 19 | Compounding Ex. 1B | Compounding Ex. 4A | 83 |
| 20 | Compounding Ex. 1B | Compounding Ex. 5A | 81 |
| 21 | Compounding Ex. 1B | Compounding Ex. 6A | 83 |
| 22 | Compounding Ex. 1B | Compounding Ex. 7A | 83 |
| 23 | Compounding Ex. 1B | Compounding Ex. 8A | 80 |
| 24 | Compounding Ex. 1B | Compounding Ex. 9A | 81 |
| 25 | Compounding Ex. 1B | Compounding Ex. 10A | 82 |
| 26 | Compounding Ex. 1B | Compounding Ex. 11A | 83 |
| 27 | Compounding Ex. 1B | Compounding Ex. 12A | 80 |
| 28 | Compounding Ex. 1B | Compounding Ex. 13A | 82 |
| 29 | Compounding Ex. 1B | Compounding Comp. Ex. | 65 |
| | | 1a | |
| 30 | Compounding Ex. 1B | Compounding Comp. Ex. | 73 |
| | | 2a | |
| 31 | Compounding Ex. 1B | Compounding Comp. Ex. | 75 |
| | | 3a | |

TABLE 9

| | Positive | Negative | Capacity after 500 |
|---|---|---|---|
| Battery No. | electrode | electrode | cycles (%) |
| 32 | 14B (Ex. 1) | 14A (Ex. 1) | 87 |
| 33 | 14B (Ex. 1) | 15A (Ex. 9) | 85 |
| 34 | 14B (Ex. 1) | 16A (Ex. 8) | 86 |
| 35 | 14B (Ex. 1) | 17A (Ex. 10) | 85 |
| 36 | 14B (Ex. 1) | 18A (Ex. 11) | 84 |
| 37 | 14B (Ex. 1) | 19A (Ex. 12) | 81 |
| 38 | 14B (Ex. 1) | 4a (Comp. Ex. 4) | 70 |
| 39 | 14B (Ex. 1) | 5a (Comp. Ex. 5) | 72 |
| 40 | 14B (Ex. 1) | 6a (Comp. Ex. 6) | 71 |
| 41 | 15B (Ex. 9) | 14A (Ex. 1) | 81 |
| 42 | 16B (Ex. 8) | 14A (Ex. 1) | 84 |
| 43 | 17B (Ex. 10) | 14A (Ex. 1) | 82 |
| 44 | 18B (Ex. 11) | 14A (Ex. 1) | 80 |
| 45 | 19B (Ex. 12) | 14A (Ex. 1) | 80 |
| 46 | 4b (Comp. Ex. 4) | 14A (Ex. 1) | 70 |
| 47 | 5b (Comp. Ex. 5) | 14A (Ex. 1) | 71 |
| 48 | 6b (Comp. Ex. 6) | 14A (Ex. 1) | 73 |
| 49 | 4b (Comp. Ex. 4) | 4a (Comp. Ex. 4) | 70 |
| 50 | 4b (Comp. Ex. 4) | 5a (Comp. Ex. 5) | 71 |
| 51 | 5b (Comp. Ex. 5) | 4a (Comp. Ex. 4) | 70 |
| 52 | 5b (Comp. Ex. 5) | 5a (Comp. Ex. 5) | 72 |

### <Preparation of Electric Double Layer Capacitor Electrode>

100 parts by weight of activated carbon (B) (KURARAY CO., LTD., RP-20), 3 parts by weight of acetylene black (C) (Denka Black) and 2 parts by weight of ketjen black (C) (Ketjen Black International Company, EC 600JD) were mixed with 5 parts by weight in terms of a solid content of the aqueous dispersion prepared in any of Compounding Examples 1A to 13A and Compounding Comparative Examples 1a to 3a. Then, to the mixture, distilled water was added, to thereby prepare a mix slurry (aqueous paste) having a solid content concentration of 50% by weight.

In the same manner, 100 parts by weight of activated carbon (B), 3 parts by weight of acetylene black (C) and 2 parts by weight of ketjen black (C) were mixed with 1.5 parts by weight in terms of a solid content of carboxymethyl cellulose (CMC 1160) prepared so as to have 1.2% by weight. The resultant was mixed with 5 parts by weight in terms of a solid content of the emulsion prepared in any of Examples 1, 8 to 12 and Comparative Examples 4 to 6. Then, to the mixture, distilled water was added, to thereby prepare a mix slurry (aqueous paste) having a solid content concentration of 50% by weight.

Then, each of these mix slurries was applied on a collector made of a strip-shaped aluminum foil having a thickness of 20 μm, and dried and compression molded, to thereby prepare an electrode having a thickness of 70 μm.

### <Adhesion Evaluation of Electric Double Layer Capacitor>

The peeling strength of the electrode prepared above was measured in the same manner as described with regard to the lithium secondary battery, and thereby the adhesion was evaluated.

Results are set forth in Tables 10 and 11.

TABLE 10

| Aqueous dispersion | Peeling strength (kN/m) |
|---|---|
| Compounding Ex. 1A | 0.35 |
| Compounding Ex. 2A | 0.36 |
| Compounding Ex. 3A | 0.35 |
| Compounding Ex. 4A | 0.36 |
| Compounding Ex. 5A | 0.34 |
| Compounding Ex. 6A | 0.35 |
| Compounding Ex. 7A | 0.36 |
| Compounding Ex. 8A | 0.35 |
| Compounding Ex. 9A | 0.34 |
| Compounding Ex. 10A | 0.34 |
| Compounding Ex. 11A | 0.34 |
| Compounding Ex. 12A | 0.35 |
| Compounding Ex. 13A | 0.36 |
| Compounding Comp. Ex. 1a | 0.31 |
| Compounding Comp. Ex. 2a | 0.33 |
| Compounding Comp. Ex. 3a | 0.33 |

TABLE 11

| Example and | |
|---|---|
| Comparative Example | Peeling strength (kN/m) |
| Ex. 1 | 0.35 |
| Ex. 9 | 0.34 |
| Ex. 8 | 0.35 |
| Ex. 10 | 0.34 |
| Ex. 11 | 0.36 |
| Ex. 12 | 0.36 |
| Comp. Ex. 4 | 0.33 |
| Comp. Ex. 5 | 0.35 |
| Comp. Ex. 6 | 0.34 |

### <Preparation of Electrolyte Solution of Electric Double Layer Capacitor>

Tetraethyl ammonium tetrafluoroborate was dissolved in propylene carbonate to prepare an electrolyte solution so as to have an electrolyte concentration of 1.5 mol/L.

### <Preparation of Coin-Shaped Electric Double Layer Capacitor>

From the above electrode, a disk having a diameter of 14 mm was stamped out, to thereby give a coin-shaped electrode having a weight of 20 mg and having a diameter of 14 mm. The coin-shaped electrode and a separator made of a microporous polypropylene film having a thickness of 25 μm and a diameter of 16 mm were laminated in the order of the electrode, the separator and the electrode in a negative electrode can of a 2032-size battery can made of stainless. Then, into the separator, 0.04 mL of the above electrolyte solution was poured. Then, on the laminate, a plate made of aluminum (thickness: 1.2 mm, diameter: 16 mm) and a spring were superposed.

Finally, via a gasket made of polypropylene, a can of the battery was placed, and a can lid was caulked in order for the battery to be hermetic therein, to thereby prepare a coin-shaped electric double layer capacitor having a diameter of 20 mm and a height of 3.2 mm.

### <Property Evaluation of Electric Double Layer Capacitor>

The coin-shaped electric double layer capacitor prepared was charged at a constant current of 10 mA for 10 minutes until the voltage reached 2.7 V, and then the coin-shaped electric double layer capacitor was discharged at a constant current of 1 mA. From the charge-discharge property obtained, an electrostatic capacity was determined.

Moreover, an internal resistance was calculated from the charge-discharge property in accordance with the calculation method of standard RC-2377 defined by Japan Electronics and Information Technology Industries Association. Results of the evaluation of capacitors using respective electrodes are set forth in Tables 12 and 13.

TABLE 12

| | Electrostatic | Internal |
|---|---|---|
| Aqueous dispersion | capacity (F/g) | resistance (ΩF) |
| Compounding Ex. 1B | 45 | 4.1 |
| Compounding Ex. 2B | 45 | 4.0 |
| Compounding Ex. 3B | 45 | 4.0 |
| Compounding Ex. 4B | 45 | 4.1 |
| Compounding Ex. 5B | 45 | 4.1 |
| Compounding Ex. 6B | 45 | 4.0 |
| Compounding Ex. 7B | 45 | 4.1 |
| Compounding Ex. 8B | 45 | 3.9 |
| Compounding Ex. 9B | 45 | 3.9 |
| Compounding Ex. 10B | 45 | 4.0 |
| Compounding Ex. 11B | 45 | 4.0 |
| Compounding Ex. 12B | 45 | 4.1 |
| Compounding Ex. 13B | 45 | 4.1 |
| Compounding Comp. Ex. 1b | 40 | 4.8 |
| Compounding Comp. Ex. 2b | 45 | 4.2 |
| Compounding Comp. Ex. 3b | 45 | 4.1 |

TABLE 13

| | Electrostatic | Internal |
|---|---|---|
| Slurry (Aqueous paste) | capacity (F/g) | resistance (ΩF) |
| 14A (Ex. 1) | 45 | 4.1 |
| 15A (Ex. 9) | 45 | 4.1 |
| 16A (Ex. 8) | 45 | 4.5 |
| 17A (Ex. 10) | 45 | 4.2 |
| 18A (Ex. 11) | 45 | 4.3 |
| 19A (Ex. 12) | 45 | 4.2 |
| 4a (Comp. Ex. 4) | 45 | 4.2 |
| 5a (Comp. Ex. 5) | 45 | 4.1 |
| 6a (Comp. Ex. 6) | 45 | 4.3 |

### <Preparation of Nickel Metal Hydride Battery Positive Electrode>

95 parts by weight of nickel hydroxide powder (B) was mixed with 5 parts by weight of acetylene black (C) (Denka Black), 4.0 parts by weight in terms of a solid content of the aqueous dispersion of any of Compounding Examples 1B to 13B and Comparative Compounding Examples 1b to 3b and distilled water, to thereby prepare a mix paste (aqueous paste) having a solid content concentration of 55% by weight.

This mix paste was applied on a nickel-plated steel plate having a thickness of 30 μm, and dried and pressure-molded, to thereby prepare a sheet-shaped positive electrode plate.

On the other hand, 95 parts by weight of nickel hydroxide powder (B) was mixed with 5 parts by weight of acetylene black (C) (Denka Black), 1.0 part by weight in terms of a solid content of carboxymethyl cellulose (CMC 1160) prepared so as to have 1.2% by weight, 2.0 parts by weight in terms of a solid content of the emulsion prepared in any of Examples 1, 8 to 12 and Comparative Examples 4 to 6, and distilled water, to thereby prepare a mix paste (aqueous paste) having a solid content concentration of 55% by weight.

This mix paste was applied on a nickel-plated steel plate having a thickness of 30 μm, and dried and pressure-molded, to thereby prepare a sheet-shaped positive electrode plate.

### <Preparation of Nickel Metal Hydride Battery Negative Electrode>

95 parts by weight of a hydrogen-absorbing alloy (B) composed of Ni, Co, Mn and Al containing a mischmetal having an average particle diameter of 30 μm was mixed with 5 parts by weight of acetylene black (C) (Denka Black), 2.5 parts by weight in terms of a solid content of the aqueous dispersion of any of Compounding Examples 1A to 13A and Compounding Comparative Examples 1a to 3a and distilled water, to thereby give a mix paste having a solid content concentration of 50% by weight.

This mix paste was applied on a punching metal having a thickness of 30 μm, and dried and pressure-molded, to thereby prepare a sheet-shaped negative electrode plate.

### <Preparation of Nickel Metal Hydride Battery Negative Electrode>

95 parts by weight of a hydrogen-absorbing alloy (B) composed of Ni, Co, Mn and Al containing a mischmetal having an average particle diameter of 30 μm was mixed with 5 parts by weight of acetylene black (C) (Denka Black) and 0.5 part by weight in terms of a solid content of carboxymethyl cellulose (CMC 1160) prepared so as to have 1.2% by weight, 1.5 parts by weight in terms of a solid content of the emulsion prepared in any of Examples 1, 8 to 12 and Comparative Examples 4 to 6 and distilled water, to thereby give a mix paste having a solid content concentration of 50% by weight.

This mix paste was applied on a punching metal having a thickness of 30 μm, and dried and pressure-molded, to thereby prepare a sheet-shaped negative electrode plate.

### <Adhesion Evaluation of Nickel Metal Hydride Battery>

The peeling strength of the electrode plate prepared above was measured in the same manner as described with regard to the lithium secondary battery and thereby the adhesion was evaluated.

Results are set forth in Tables 14 and 15.

TABLE 14

| | | Peeling strength |
|---|---|---|
| Electrode | Aqueous binder | (kN/m) |
| Negative electrode | Compounding Ex. 1A | 0.33 |
| Negative electrode | Compounding Ex. 2A | 0.34 |
| Negative electrode | Compounding Ex. 3A | 0.34 |
| Negative electrode | Compounding Ex. 4A | 0.33 |
| Negative electrode | Compounding Ex. 5A | 0.33 |
| Negative electrode | Compounding Ex. 6A | 0.34 |
| Negative electrode | Compounding Ex. 7A | 0.33 |
| Negative electrode | Compounding Ex. 8A | 0.34 |
| Negative electrode | Compounding Ex. 9A | 0.34 |
| Negative electrode | Compounding Ex. 10A | 0.33 |
| Negative electrode | Compounding Ex. 11A | 0.33 |
| Negative electrode | Compounding Ex. 12A | 0.33 |
| Negative electrode | Compounding Ex. 13A | 0.33 |
| Negative electrode | Compounding Comp. Ex. 1a | 0.31 |
| Negative electrode | Compounding Comp. Ex. 2a | 0.30 |
| Negative electrode | Compounding Comp. Ex. 3a | 0.32 |
| Positive electrode | Compounding Ex. 1B | 0.29 |
| Positive electrode | Compounding Ex. 2B | 0.30 |
| Positive electrode | Compounding Ex. 3B | 0.29 |
| Positive electrode | Compounding Ex. 4B | 0.30 |
| Positive electrode | Compounding Ex. 5B | 0.29 |
| Positive electrode | Compounding Ex. 6B | 0.30 |
| Positive electrode | Compounding Ex. 7B | 0.31 |
| Positive electrode | Compounding Ex. 8B | 0.31 |
| Positive electrode | Compounding Ex. 9B | 0.29 |
| Positive electrode | Compounding Ex. 10B | 0.30 |
| Positive electrode | Compounding Ex. 11B | 0.29 |
| Positive electrode | Compounding Ex. 12B | 0.30 |
| Positive electrode | Compounding Ex. 13B | 0.30 |
| Positive electrode | Compounding Comp. Ex. 1b | 0.26 |
| Positive electrode | Compounding Comp. Ex. 2b | 0.27 |
| Positive electrode | Compounding Comp. Ex. 3b | 0.28 |

TABLE 15

| | | Peeling strength |
|---|---|---|
| Electrode | Slurry (Aqueous paste) | (kN/m) |
| Negative electrode | 14A (Ex. 1) | 0.33 |
| Negative electrode | 15A (Ex. 9) | 0.32 |
| Negative electrode | 16A (Ex. 8) | 0.35 |
| Negative electrode | 17A (Ex. 10) | 0.34 |
| Negative electrode | 18A (Ex. 11) | 0.33 |
| Negative electrode | 19A (Ex. 12) | 0.34 |
| Negative electrode | 4a (Comp. Ex. 4) | 0.3 |
| Negative electrode | 5a (Comp. Ex. 5) | 0.32 |
| Negative electrode | 6a (Comp. Ex. 6) | 0.31 |
| Positive electrode | 14A (Ex. 1) | 0.29 |
| Positive electrode | 15A (Ex. 9) | 0.28 |
| Positive electrode | 16A (Ex. 8) | 0.29 |
| Positive electrode | 17A (Ex. 10) | 0.28 |
| Positive electrode | 18A (Ex. 11) | 0.29 |
| Positive electrode | 19A (Ex. 12) | 0.29 |
| Positive electrode | 4a (Comp. Ex. 4) | 0.27 |
| Positive electrode | 5a (Comp. Ex. 5) | 0.28 |
| Positive electrode | 6a (Comp. Ex. 6) | 0.28 |

### <Preparation of Nickel Metal Hydride Battery>

From the above negative electrode plate or the above positive electrode plate, a disk having a diameter of 14 mm was stamped out, to thereby give a coin-shaped electrode having a weight of 20 mg and a diameter of 14 mm.

The coin-shaped electrodes and a separator composed of a microporous polypropylene film having a thickness of 25 μm and a diameter of 16 mm were laminated in the order of the negative electrode, the separator and the positive electrode in a negative electrode can of a 2032-size battery can made of stainless. Then, a potassium hydroxide aqueous solution (specific gravity at 20° C.: 1.3) was poured. On the laminate, a plate made of aluminum (thickness: 1.2 mm, diameter: 16 mm) and a spring were superposed.

Finally, via a gasket made of polypropylene, a positive electrode can of the battery was placed, and a can lid was caulked in order for the battery to be hermetic therein, to thereby prepare a coin-shaped battery having a diameter of 20 mm and a height of 3.2 mm.

### <Evaluation of Battery Cycle Property>

The coin battery prepared above was charged at 0.2 ItA until the voltage reached −Δ10 mV, and then the coin battery was discharged at 0.2 ItA until the voltage reached 1 V. This cycle was repeated 500 times. Then, a capacity (%) after 500 cycles relative to an initial battery capacity was evaluated.

Evaluation results are set forth in Tables 16 and 17.

TABLE 16

| | | | Capacity |
|---|---|---|---|
| | | | after |
| | Positive | Negative | 500 cycles |
| Battery No. | electrode | electrode | (%) |
| 1 | Compounding Ex. 1B | Compounding Ex. 1A | 78 |
| 2 | Compounding Ex. 2B | Compounding Ex. 1A | 76 |
| 3 | Compounding Ex. 3B | Compounding Ex. 1A | 70 |
| 4 | Compounding Ex. 4B | Compounding Ex. 1A | 72 |
| 5 | Compounding Ex. 5B | Compounding Ex. 1A | 73 |
| 6 | Compounding Ex. 6B | Compounding Ex. 1A | 75 |
| 7 | Compounding Ex. 7B | Compounding Ex. 1A | 74 |
| 8 | Compounding Ex. 8B | Compounding Ex. 1A | 78 |
| 9 | Compounding Ex. 9B | Compounding Ex. 1A | 74 |
| 10 | Compounding Ex. 10B | Compounding Ex. 1A | 72 |
| 11 | Compounding Ex. 11B | Compounding Ex. 1A | 72 |
| 12 | Compounding Ex. 12B | Compounding Ex. 1A | 74 |
| 13 | Compounding Ex. 13B | Compounding Ex. 1A | 76 |
| 14 | Compounding Comp. | Compounding Ex. 1A | 57 |
| | Ex. 1b | | |
| 15 | Compounding Comp. | Compounding Ex. 1A | 69 |
| | Ex. 2b | | |
| 16 | Compounding Comp. | Compounding Ex. 1A | 68 |
| | Ex. 3b | | |
| 17 | Compounding Ex. 1B | Compounding Ex. 2A | 72 |
| 18 | Compounding Ex. 1B | Compounding Ex. 3A | 72 |
| 19 | Compounding Ex. 1B | Compounding Ex. 4A | 76 |
| 20 | Compounding Ex. 1B | Compounding Ex. 5A | 77 |
| 21 | Compounding Ex. 1B | Compounding Ex. 6A | 73 |
| 22 | Compounding Ex. 1B | Compounding Ex. 7A | 73 |
| 23 | Compounding Ex. 1B | Compounding Ex. 8A | 70 |
| 24 | Compounding Ex. 1B | Compounding Ex. 9A | 71 |
| 25 | Compounding Ex. 1B | Compounding Ex. 10A | 72 |
| 26 | Compounding Ex. 1B | Compounding Ex. 11A | 73 |
| 27 | Compounding Ex. 1B | Compounding Ex. 12A | 70 |
| 28 | Compounding Ex. 1B | Compounding Ex. 13A | 74 |
| 29 | compounding Ex. 1B | Compounding Comp. | 40 |
| | | Ex. 1a | |
| 30 | compounding Ex. 1B | Compounding Comp. | 68 |
| | | Ex. 2a | |
| 31 | compounding Ex. 1B | Compounding Comp. | 67 |
| | | Ex. 3a | |

TABLE 17

| | Positive | Negative | Capacity after |
|---|---|---|---|
| Battery No. | electrode | electrode | 500 cycles (%) |
| 32 | 14B (Ex. 1) | 14A (Ex. 1) | 72 |
| 33 | 14B Ex. 1) | 15A (Ex. 9) | 75 |
| 34 | 14B Ex. 1) | 16A (Ex. 8) | 78 |
| 35 | 14B (Ex. 1) | 17A (Ex. 10) | 73 |
| 36 | 14B (Ex. 1) | 18A (Ex. 11) | 74 |
| 37 | 14B (Ex. 1) | 19A (Ex. 12) | 71 |
| 38 | 14B (Ex. 1) | 4a (Comp. Ex. 4) | 64 |
| 39 | 14B (Ex. 1) | 5a (Comp. Ex. 5) | 69 |
| 40 | 14B (Ex. 1) | 6a (Comp. Ex. 6) | 67 |
| 41 | 15B (Ex. 9) | 14A (Ex. 1) | 75 |
| 42 | 16B (Ex. 8) | 14A (Ex. 1) | 77 |
| 43 | 17B (Ex. 10) | 14A (Ex. 1) | 74 |
| 44 | 18B (Ex. 11) | 14A (Ex. 1) | 72 |
| 45 | 19B (Ex. 12) | 14A (Ex. 1) | 71 |
| 46 | 4a (Comp. Ex. 4) | 14A (Ex. 1) | 65 |
| 47 | 5a (Comp. Ex. 5) | 14A (Ex. 1) | 66 |
| 48 | 6a (Comp. Ex. 6) | 14A (Ex. 1) | 66 |
| 49 | 4a (Comp. Ex. 4) | 4a (Comp. Ex. 4) | 65 |
| 50 | 4a (Comp. Ex. 4) | 5a (Comp. Ex. 5) | 65 |
| 51 | 5a (Comp. Ex. 5) | 4a (Comp. Ex. 4) | 65 |
| 52 | 5a (Comp. Ex. 5) | 5a (Comp. Ex. 5) | 66 |

As demonstrated in the foregoing, the battery obtained using the paste for an electrochemical paste of the present invention is electrochemically stable, and provides adhesive power and swells less. In particular, a battery having high charge-discharge cycle life can be obtained.

### Preparation of Aqueous Dispersion for an Electrochemical Cell (A)

### Example 13

Into an autoclave, as an olefin copolymer (a), 250 parts of an ethylene-acrylic acid copolymer (weight average molecular weight of 80,000 (in terms of polystyrene), content of a structural unit derived from acrylic acid: 20% by weight) (a-3); 33 parts of 25% by weight ammonia water; and 1008 parts of deionized water were charged, and stirred for 2 hours at 180° C. and then cooled, to thereby give an emulsion comprising an olefin copolymer (a) having a volume average particle diameter of 45 nm and a nonvolatile content of 25% (melting point: 60° C.).

A four-neck flask equipped with a Dimroth condenser, a nitrogen-introducing tube and an agitating blade was purged with nitrogen and charged with 100 parts by weight of the emulsion obtained. Thereto, 36 parts by weight of NONSAL OK-2 (manufactured by NOF CORPORATION) diluted with ion exchange water so as to have 20% by weight was gently added with stirring. Then, 36 parts by weight of OLFINE E1010 (manufactured by Nissin Chemical Industry Co., Ltd.) diluted with ion exchange water so as to have 5% by weight was added in the same manner. Then, deionized water was added so that a final solid content would have 18.3% by weight, and the mixture was stirred for 30 minutes, to thereby give an aqueous dispersion (A) 20B comprising a translucent white olefin copolymer (a).

### Example 14

100 parts by weight of a random polypropylene (a-1) having a weight average molecular weight of 100,000 and containing a total of 30% by weight of ethylene and butene as a copolymerization component was mixed with 10 parts by weight of a maleic-modified polypropylene (a-4) having a weight average molecular weight of 20,000 and a maleic-modification degree of 4. The resultant was further mixed with 4 parts of potassium oleate. The resultant mixture was melt-kneaded with a biaxial extruder at 200° C., which is followed by kneading while adding a potassium hydroxide aqueous solution, to thereby give an olefin copolymer (a) having a nonvolatile content of 45% (melting point: not observed).

Preparation was performed in the same manner as in Example 13, except that the ethylene-acrylic acid copolymer (a-3) of Example 13 was replaced with the olefin copolymer (a) obtained above in the same amount in terms of a solid content, to thereby give an aqueous dispersion 21B comprising a translucent white olefin copolymer (a) having a solid content of 19% by weight.

### Example 15

Into an autoclave, 250 parts of an ethylene-methacrylic acid copolymer (weight average molecular weight of 80,000 (in terms of polystyrene), content of a structural unit derived from methacrylic acid: 15% by weight) (a-3), 9 parts of sodium hydroxide and 764 parts of deionized water were charged, and stirred at 180° C. for 2 hours and then cooled, to thereby give an aqueous dispersion 20A comprising a translucent white olefin copolymer (a) (melting point: 85° C.) having a volume average particle diameter of 20 nm and a solid content of 25%.

### Example 16

Into an autoclave, 250 parts of an ethylene-methacrylic acid copolymer (weight average molecular weight of 80,000 (in terms of polystyrene), content of a structural unit derived from methacrylic acid: 12%) (a-3), 7.5 parts of sodium hydroxide and 455 parts of deionized water were charged, and stirred at 180° C. for 2 hours and then cooled, to thereby give an aqueous dispersion 21A comprising a translucent white olefin copolymer (a) (melting point: 85° C.) having a volume average particle diameter of 300 nm and a solid content of 35.8%.

### Comparative Example 7

100 parts by weight of a maleic-modified crystalline random polypropylene having a weight average molecular weight of 100,000 and a maleic-modification degree of 0.7 and containing a total of 5% by weight of ethylene and butene as a copolymerization component was mixed with 20 parts by weight of a maleic-modified polypropylene having a weight average molecular weight of 20,000 and a maleic-modification degree of 4, to thereby give a copolymer (melting point: 140° C.). The copolymer was mixed with 6 parts by weight of potassium oleate, and melt-kneaded with a biaxial extruder at 200° C. The mixture was further kneaded while adding a potassium hydroxide aqueous solution. The product discharged was dispersed in water, to thereby give an emulsion having a volume average particle diameter of 300 nm and a nonvolatile content of 45% (melting point: 140° C.).

Preparation was performed in the same manner as in Example 13, except that the emulsion obtained was used in the same amount as the amount in terms of a solid content of the olefin copolymer (a) of Example 14, to thereby give a translucent white emulsion 7b having a solid content of 19.2% by weight.

### Comparative Example 8

A high-molecular weight polypropylene resin (manufactured by Japan Polypropylene Corporation, NOVATEC PP, BC3H, propylene homopolymer) was subjected to heat degradation treatment at 360° C. for 80 minutes under the flowing of a nitrogen gas under ordinary pressure to give a propylene resin. 80 parts of the propylene resin was introduced to a three-neck flask with a cooling tube, which was purged with nitrogen. The resin was melted by increasing the temperature to 180° C. Then, 10 parts of maleic anhydride was added, and the mixture was homogenously mixed. Thereto, 10 parts of xylene dissolving 0.5 part of dicumylperoxide was dropwise added, and the mixture was stirred at 180° C. for 3 hours. Then, under vacuum, xylene was distilled off. The resin was washed several times with acetone, to thereby remove unreacted maleic anhydride. The resultant was then vacuum-dried in a vacuum dryer, to thereby give an acid-modified polyolefin resin (weight average molecular weight: 30,000, maleic-modification degree: 9).

A sealable pressure-resistant 1 L glass container equipped with a stirrer and a heater was charged with 100 g of the acid-modified polyolefin resin obtained, 12 g of triethylamine as a basic compound, 100 g of isopropyl alcohol as an organic solvent and 288 g of distilled water, and sealed, and then the mixture was heated to 160° C. (the temperature of the mixture) while stirred with an agitating blade at 200 rpm. Under stirring, the mixture was held at 160° C. for 1 hour. Then, the heater was turned off and the mixture was allowed to cool to room temperature under stirring. After cooling, the mixture was subjected to filtration under pressure (air pressure: 0.2 MPa) using a 300-mesh stainless filter (linear diameter: 0.035 mm, plain fabrics), to thereby give a slightly-yellowish semitransparent homogenous emulsion (solid content concentration: 20% by mass) (melting point: 140° C.).

Preparation was performed in the same manner as in Example 13, except that the emulsion obtained was used in the same amount as the amount in terms of a solid content of the olefin copolymer (a) of Example 13, to thereby give a translucent white emulsion 8b having a solid content of 17% by weight.

<Preparation of Viscosity Modifier (y1)>

A four-neck flask equipped with a Dimroth condenser, a nitrogen-introducing tube and an agitating blade was charged with 1,000 parts by weight of ion exchange water and purged with nitrogen. Thereto, as a viscosity modifier, 150 parts by weight of powder of polyvinyl alcohol (KL-318 manufactured by KURARAY CO., LTD., weight average molecular weight: 70,000) was gradually added with stirring. After the adding, the temperature of the mixture in the flask was increased to 80° C. When the temperature reached 80° C., the mixture was stirred for 1 hour, and then was allowed to cool to room temperature.

The viscosity modifier aqueous solution (y1) obtained was a transparent liquid having a solid content of 14.4% by weight.

### <Preparation of Aqueous Paste and Electrode Plate>

### (Preparation of Aqueous Paste (1))

100 g of olivine LiFePO₄ powder (B) (particle size distribution D50: 0.54 μm, specific surface area (BET): 15 m²/g); 9 g of powder acetylene black (C) (particle size distribution D50: 0.04 μm, BET specific surface area: 68 m²/g); 76 g of the aqueous dispersion (A) 21B comprising an olefin copolymer (a) (solid content concentration: 18.3 wt %); 37 g of the viscosity modifier aqueous solution (y1) (solid content concentration: 14.4 wt %); and 38 g of ion exchange water were stirred and mixed with one another using a FILMIX 40-40 (manufactured by PRIMIX Corporation) under room temperature, to thereby give an aqueous paste (1) (solid content concentration: 51 wt %).

### (Preparation of Positive Electrode Plate (1))

The aqueous paste (1) was applied on both sides of a rolled Al foil (thickness: 20 μm) with an applicator, and dried at 100° C. for 30 minutes in atmosphere and pressed, to thereby give a positive electrode plate (1) (coated surface size: 150 mm (length)×70 mm (width)×285 μm (thickness)).

The amount of the active material applied on the positive electrode plate was 5 mg/cm², and the packing density of the active material applied on the positive electrode plate was 1.9 g/cm³. The electrode plate had an electricity capacity of 0.6 mAh/cm².

### (Preparation of Aqueous Paste (2))

100 g of spherical natural graphite powder (B) (particle size distribution D50: 19.9 μm, specific surface area: 4.0 m²/g); 11 g of artificial graphite powder (C) (particle size distribution D50: 21.0 μm, specific surface area: 4.2 m²/g); 5 g of the aqueous dispersion 20A comprising an olefin copolymer (a) (solid content concentration: 35.8 wt %); 76 g of an aqueous solution containing a thickening agent (1) (CMC (average molecular weight: 2200, etherification degree: 0.97), manufactured by Daicel Finechem Ltd.) (solid content concentration: 1.5 wt %); and 41 g of ion exchange water were stirred and kneaded with one another using a biaxial planetary mixer under room temperature, to thereby give an aqueous paste (2) (solid content concentration: 49 wt %).

### (Preparation of Negative Electrode Plate (2))

The aqueous paste (2) was applied on both sides of a rolled Cu foil (thickness: 10 μm) with an applicator, and dried at 100° C. for 30 minutes in atmosphere and pressed, to thereby give a negative electrode plate (2) (coated surface size: 154 mm (length)×74 mm (width)×195 μm (thickness)).

The amount of the active material applied on the negative electrode plate was 3 mg/cm², and the packing density of the active material applied on the negative electrode plate was 1.6 g/cm³. The electrode plate had an electricity capacity of 0.9 mAh/cm².

### (Preparation of Aqueous Paste (3))

100 g of olivine LiFePO₄ powder (B) (particle size distribution D50: 8.2 μm, specific surface area: 6 m²/g); 9 g of artificial graphite powder (C) (particle size distribution D50: 78.8 μm, specific surface area: 2.2 m²/g); 76 g of the aqueous dispersion 20B comprising an olefin copolymer (a) (solid content concentration: 18.3 wt %); 37 g of the viscosity modifier aqueous solution (y1) (solid content concentration: 14.4 wt %); and 38 g of ion exchange water were stirred and mixed with one another using a FILMIX 40-40 under room temperature, to thereby give an aqueous paste (3) (solid content concentration: 51 wt %).

### (Preparation of Positive Electrode Plate (3))

The aqueous paste (3) was applied on both sides of a rolled Al foil (thickness: 20 μm) with an applicator, and dried at 100° C. for 30 minutes in atmosphere and pressed, to thereby give a positive electrode plate (3) (coated surface size: 150 mm (length)×70 mm (width)×805 μm (thickness)).

The amount of the active material applied on the positive electrode plate was 88 mg/cm², and the packing density of the active material applied on the positive electrode plate was 1.1 g/cm³. The electrode plate had an electricity capacity of 11.9 mAh/cm².

### (Preparation of Aqueous Paste (4))

100 g of spherical natural graphite powder (B) (particle size distribution D50: 15.2 μm, specific surface area: 2.1 m²/g); 11 g of artificial graphite powder (C) (particle size distribution D50: 3.5 μm, specific surface area: 20.0 m²/g); 5 g of the aqueous dispersion 21A comprising an olefin copolymer (a) (solid content concentration: 35.8 wt %); 76 g of the thickening agent (1); and 41 g of ion exchange water were stirred and kneaded with one another using a biaxial planetary mixer under room temperature, to thereby give an aqueous paste (4) (solid content concentration: 49 wt %).

### (Preparation of Negative Electrode Plate (4))

The aqueous paste (4) was applied on both sides of an electrolyzed Cu foil (thickness: 10 μm) with an applicator, and dried at 100° C. for 30 minutes in atmosphere and pressed, to thereby give a negative electrode plate (4) (coated surface size: 154 mm (length)×74 mm (width)×425 μm (thickness)).

The amount of the active material applied on the negative electrode plate was 46 mg/cm², and the packing density of the active material applied on the negative electrode plate was 1.1 g/cm³. The electrode plate had an electricity capacity of 13.8 mAh/cm².

### (Preparation of Non-Aqueous Paste (5))

100 g of olivine LiFePO₄ powder (B) (particle size distribution D50: 8.2 μm, specific surface area: 6 m²/g); 12 g of artificial graphite powder (C) (particle size distribution D50: 78.8 μm, specific surface area: 2.2 m²/g); and 113 g of a n-methyl pyrrolidone (NMP, manufactured by KISHIDA CHEMICAL Co., Ltd., special grade) solution (solid content concentration: 12.3 wt %) of polyvinylidene fluoride (PVDF, weight average molecular weight: 280,000, manufactured by KUREHA CORPORATION) were stirred and kneaded with one another using a biaxial planetary mixer under room temperature, to thereby give a non-aqueous paste (5) (solid content concentration: 56 wt %).

### (Preparation of Positive Electrode Plate (5))

The non-aqueous paste (5) was applied on both sides of a rolled Al foil (thickness: 20 μm) with an applicator, and dried at 150° C. for 30 minutes in atmosphere and pressed, to thereby give a positive electrode plate (5) (coated surface size: 150 mm (length)×70 mm (width)×805 μm (thickness)).

The amount of the active material applied on the positive electrode plate was 70 mg/cm², and the packing density of the active material applied on the positive electrode plate was 0.9 g/cm³. The electrode plate had an electricity capacity of 9.4 mAh/cm².

### (Preparation of Non-Aqueous Paste (6))

100 g of spherical natural graphite powder (B) (particle size distribution D50: 15.2 μm, specific surface area: 2.1 m²/g); 11 g of artificial graphite powder (C) (particle size distribution D50: 3.5 μm, specific surface area: 20.0 m²/g); 54 g of a NMP solution (solid content concentration: 12.9 wt %) of PVDF (weight average molecular weight: 280,000); and 60 g of NMP were stirred and kneaded with one another using a biaxial planetary mixer under room temperature, to thereby give a non-aqueous paste (6) (solid content concentration: 52 wt %).

### (Preparation of Negative Electrode Plate (6))

The non-aqueous paste (6) was applied on both sides of an electrolyzed Cu foil (thickness: 10 μm) with an applicator, and dried at 150° C. for 30 minutes in atmosphere and pressed, to thereby give a negative electrode plate (6) (coated surface size: 154 mm (length)×74 mm (width)×425 μm (thickness)).

The amount of the active material applied on the negative electrode plate was 38 mg/cm², and the packing density of the active material applied on the negative electrode plate was 0.9 g/cm³. The electrode plate had an electricity capacity of 11.4 mAh/cm².

### (Preparation of Aqueous Paste (7))

100 g of olivine LiFePO₄ powder (B) (particle size distribution D50: 0.54 μm, specific surface area (BET): 15 m²/g); 9 g of powder acetylene black (C) (particle size distribution D50: 0.04 μm, BET specific surface area: 68 m²/g); 76 g of the emulsion 7b (solid content concentration: 18.3 wt %); 37 g of the viscosity modifier aqueous solution (y1) (solid content concentration: 14.4 wt %); and 38 g of ion exchange water were stirred and mixed with one another using a FILMIX 40-40 (manufactured by PRIMIX Corporation) under room temperature, to thereby give an aqueous paste (7) (solid content concentration: 51 wt %).

### (Preparation of Positive Electrode Plate (7))

The aqueous paste (7) was applied on both sides of a rolled Al foil (thickness: 20 μm) with an applicator, and dried at 100° C. for 30 minutes in atmosphere and pressed. Thereby, the attempt to obtain a positive electrode plate was made. However, the mix layer had cracking and the mix was peeled off from the electrode plate. Thus, the preparation of the electrode plate was impossible.

### (Preparation of Aqueous Paste (8))

100 g of olivine LiFePO₄ powder (B) (particle size distribution D50: 0.54 μm, specific surface area (BET): 15 m²/g); 9 g of powder acetylene black (C) (particle size distribution D50: 0.04 μm, BET specific surface area: 68 m²/g); 76 g of the emulsion 8b (solid content concentration: 18.3 wt %); 37 g of the viscosity modifier aqueous solution (y1) (solid content concentration: 14.4 wt %); and 38 g of ion exchange water were stirred and mixed with one another using a FILMIX 40-40 (manufactured by PRIMIX Corporation) under room temperature, to thereby give an aqueous paste (8) (solid content concentration: 51 wt %).

### (Preparation of Positive Electrode Plate (8))

The aqueous paste (8) was applied on both sides of a rolled Al foil (thickness: 20 μm) with an applicator, and dried at 100° C. for 30 minutes and pressed. Thereby, the attempt to obtain a positive electrode plate was made. However, the mix layer had cracking and the mix was peeled off from the electrode plate. Thus, the preparation of the electrode plate was impossible.

### <Flexure Test of Electrode Plate>

As shown in FIGS. 2 and 3, with regard to the positive electrode plate (1), the positive electrode plate (3), the negative electrode plate (2) and the negative electrode plate (4), one side of each plate was wound around a SUS tube having a diameter of 50 mm. Then, the other side of each plate was wound in the same manner. Thereafter, the electrode material on the surface of the electrode plate was visually observed to see whether the electrode material peeled or cracked. As a result, with regard to the positive electrode plate (1), the negative electrode plate (2) and the negative electrode plate (4), neither peeling nor cracking was observed. With regard to the positive electrode plate (3), microcracking was observed, but the degree of the crackling was tolerable as an electrode plate.

On the other hand, with regard to the positive electrode plate (5) and the negative electrode plate (6), the same test was carried out. As a result, with regard to the positive electrode plate (5), a large cracking (crack) occurred on the surface. With regard to the negative electrode plate (6), the electrode material partially fell off from the rolled Cu foil.

This test was carried out to study as to whether the electrode plate was capable of going through a supporting bar in a roll-to-roll process, in view of the possibility of performing the step of applying the electrode material on the metal foil using a continuous-coating machine.

### <Preparation of Battery I>

The positive electrode plate (1) and the negative electrode plate (2) were dried under vacuum at 130° C. for 24 hours, and placed in a glovebox under Ar atmosphere. Assembling a battery described below was entirely carried out in the glovebox under room temperature.

On the negative electrode plate (2), a polyethylene (PE) microporous film (1) (156 mm (length)×76 mm (width)×25 μm (thickness), voids: 55%) was placed. Thereon, a positive electrode plate (1) was superposed, and thereon another PE microporous film (1) was superposed. By repeating this operation, a laminate was prepared which was composed of six pieces of the negative electrode plate (2), five pieces of the positive electrode plate (1) and ten pieces of the PE microporous film (1) each held between respective electrode plates. To six pieces of the negative electrode plate (2), Ni lead wires were ultrasonically welded, and to five pieces of the positive electrode plate (1), Al lead wires were ultrasonically welded. Then, the laminate was inserted into an Al laminated bag, and three sides of the Al laminated bag were heat sealed. 60 mL of an electrolyte solution obtained by dissolving LiPF₆ in a solvent so as to have 1 mol/L, the solvent being obtained by mixing ethylene carbonate (EC) and diethyl carbonate (DEC) at a volume ratio of 1:2, was poured into the cell. While taking out respective lead wires, the other side of the Al laminated bag was heat sealed. Thereby, a battery I was obtained.

### <Preparation of Battery II>

The positive electrode plate (3) and the negative electrode plate (4) were dried under vacuum at 130° C. for 24 hours, and placed in a glovebox under Ar atmosphere. Assembling a battery described below was entirely carried out in the glovebox under room temperature.

On the negative electrode plate (4), a polypropylene (PP) microporous film (2) (156 mm (length)×76 mm (width)×25 μm (thickness), voids: 50%) was placed. Thereon, a positive electrode plate (3) was superposed, and thereon another PP microporous film (2) was superposed. By repeating this operation, a laminate was prepared which was composed of six pieces of the negative electrode plate (4), five pieces of the positive electrode plate (3) and ten pieces of the PP microporous film (2) each held between respective electrode plates. To six pieces of the negative electrode plate (4), Ni leads were ultrasonically welded, and to five pieces of the positive electrode plate (3), Al lead wires were ultrasonically welded. Then, the laminate was inserted into an Al laminated bag, and three sides of the Al laminated bag were heat sealed. 100 mL of an electrolyte solution obtained by dissolving LiPF₆ in a solvent so as to have 1 mol/L, the solvent being obtained by mixing EC, dimethyl carbonate (DMC) and DEC at a volume ratio of 1:1:1, was poured into the cell. While taking out respective lead wires, the other side of the Al laminated bag was heat sealed. Thereby, a battery II was obtained.

### <Preparation of Battery III>

The positive electrode plate (5) and the negative electrode plate (6) were dried under vacuum at 130° C. for 24 hours, and placed in a glovebox under Ar atmosphere. Assembling a battery described below was entirely carried out in the glovebox under room temperature.

On the negative electrode plate (6), a polypropylene (PP) microporous film (2) was placed. Thereon, a positive electrode plate (5) was superposed, and thereon another PP microporous film (2) was superposed. By repeating this operation, a laminate was prepared which was composed of six pieces of the negative electrode plate (6) and five pieces of the positive electrode plate (5) and ten pieces of the PP microporous film (2) each held between respective electrode plates. To six pieces of the negative electrode plate (6), Ni lead wires were ultrasonically welded, and to five pieces of the positive electrode plate (5), Al lead wires were ultrasonically welded. Then, the laminate was inserted into an Al laminated bag, and three sides of the Al laminated bag were heat sealed. 100 mL of an electrolyte solution obtained by dissolving LiPF₆ in a solvent so as to have 1 mol/L, the solvent being obtained by mixing EC, DMC and DEC at a volume ratio of 1:1:1, was poured into the cell. While taking out respective lead wires, the other side of the Al laminated bag was heat sealed. Thereby, a battery III was obtained.

### <Initial Charging-Discharging of Battery and 500-Cycle Test of Battery>

### (Battery I)

The battery I was charged at a constant current of 0.1 C (current value capable of discharging a battery capacity in 10 hours) until the battery voltage reached 3.8 V. Thereafter, the battery I was charged at a constant voltage of 3.8 V until the current value reached 0.01 C (current value capable of discharging a battery capacity in 100 hours). The charge capacity was 310 mAh (initial charge capacity).

Then, the battery I was discharged at a constant current of 0.1 C until the battery voltage reached 2.2 V. The charge capacity was 280 mAh (initial discharge capacity).

The above charging-discharging was repeated 500 times, and the discharge capacity thereafter was 250 mAh. This measurement was entirely carried out in a thermostatic chamber at 25° C.

### (Battery II)

In the same manner as described for the battery I, the battery II was charged and discharged. As a result, the initial charge capacity was 6200 mAh and the initial discharge capacity was 5600 mAh.

The discharge capacity after repeating the cycle 500 times was 4500 mAh.

### (Battery III)

In the same manner as described for the battery I, the battery III was charged and discharged. As a result, the initial charge capacity was 4900 mAh and the initial discharge capacity was 3700 mAh.

The discharge capacity after repeating the cycle 500 times was 2300 mAh.

<Measurement of Internal Resistance of Battery at an Initial Stage and after 500 Cycles>

### (Battery I)

With respect to the battery I, the initial charging-discharging as described above was performed. Then, an impedance value in the case of polarization at 1 kHz and at a battery voltage ±5 mV was measured. As a result, the impedance was 15 mΩ (initial internal resistance).

In the same manner, with respect to the battery I after 500 cycles, an impedance value was measured. As a result, the impedance was 20 mΩ (internal resistance after 500 cycles). This measurement was entirely carried out in a thermostatic chamber at 25° C.

### (Battery II)

In the same manner as described for the battery I, internal resistance values of the battery at an initial stage and after 500 cycles were measured. As a result, the initial internal resistance was 150 mΩ, and the internal resistance after 500 cycles was 160 mΩ.

### (Battery III)

In the same manner as described for the battery I, internal resistance values of the battery at an initial stage and after 500 cycles were measured. As a result, the initial internal resistance was 160 mΩ, and the internal resistance after 500 cycles was 350 mΩ.

### <Evaluation of Discharge Rate Property of Battery>

### (Battery I)

The battery I was charged at a constant current of 0.1 C until the battery voltage reached 3.8 V. Then, the battery I was charged at a constant voltage of 3.8 V until the current value reached 0.01 C. Subsequently, the battery I was discharged at a constant current of 1.0 C (current value capable of discharging a battery capacity in 1 hour) until the battery voltage reached 2.2 V. The discharge capacity at this time was 274 mAh (discharge capacity after 1.0 C). This measurement was entirely carried out in a thermostatic chamber at 25° C.

The discharge rate property of the battery was evaluated based on a ratio (1 C/0.1 C) of the discharge capacity of the battery I after 1.0 C to the initial discharge capacity of the battery I, 280 mAh. As a result, the ratio was 98%.

### (Battery II)

In the same manner as described for the battery I, the discharge rate property of the battery was evaluated. As a result, the discharge capacity after 1.0 C was 4760 mAh, and the ratio (1 C/0.1 C) was 85%.

### (Battery III)

In the same manner as described for the battery I, the discharge rate property of the battery was evaluated. As a result, the discharge capacity after 1.0 C was 2890 mAh, and the ratio (1 C/0.1 C) was 78%.

As demonstrated in the foregoing, the aqueous paste according to the present invention provides electrodes with excellent binding strength, and thus can sufficiently withstand continuous coating process of applying the aqueous paste on a metal foil. Moreover, the battery using such an electrode has extremely high charge-discharge cycle life

### DESCRIPTION OF MARKS

1 electrode plate
2 SUS tube having a diameter of 50 mm
3 sliding direction of an electrode plate
3a positive electrode plate
3b negative electrode plate
4 separator 4
5 outer package material
6 non-aqueous electrolyte

1. A non-aqueous electrolyte secondary battery comprising a positive electrode plate for an electrochemical cell and a negative electrode plate for an electrochemical cell,
wherein the positive electrode plate for an electrochemical cell is obtained by applying an aqueous paste for an electrochemical cell (1),
wherein the aqueous paste for an electrochemical cell (1) comprises
an aqueous dispersion for an electrochemical cell (A) that comprises an olefin copolymer (a) being an ethylene-(meth)acrylic acid copolymer (a-3) having a weight average molecular weight, as determined by gel permeation chromatography (GPC), of not less than 50,000 (in terms of polystyrene) and containing 5% by weight to 25% by weight of a structural unit derived from (meth)acrylic acid;
an active material (B) that comprises olivine LiFePO₄ having a median diameter (D50), as measured by laser diffraction scattering method, of 0.5 to 9 μm and having a specific surface area of 5 to 30 m²/g, wherein the amount of the active material (B) applied on the positive electrode plate for an electrochemical cell is 4 to 90 mg/cm²; and
a conductive assistant (C),
wherein the negative electrode plate for an electrochemical cell is obtained by applying an aqueous paste for an electrochemical cell (2),
wherein the aqueous paste for an electrochemical cell (2) comprises
an aqueous dispersion for an electrochemical cell (A) that comprises an olefin copolymer (a) being at least one kind selected from a random propylene copolymer (a-1) having a weight average molecular weight, as determined by gel permeation chromatography (GPC), of from 50,000 to 100,000 (in terms of polystyrene) and containing 50% by weight to less than 85% by weight of a structural unit derived from propylene, an acid-modified random propylene copolymer (a-2) obtained by modifying the random propylene copolymer (a-1) with an acid, and an ethylene-(meth)acrylic acid copolymer (a-3) having a weight average molecular weight, as determined by gel permeation chromatography (GPC), of not less than 50,000 (in terms of polystyrene) and containing 5% by weight to less than 25% by weight of a structural unit derived from (meth)acrylic acid;
an active material (B) that comprises spherical natural graphite, wherein the amount of the active material (B) applied on the negative electrode plate for an electrochemical cell is 2 to 50 mg/cm²; and
a conductive assistant (C).

2. The non-aqueous electrolyte secondary battery according to claim 1,
wherein, in the aqueous paste for an electrochemical cell (1) or in the aqueous paste for an electrochemical cell (2), based on 100 parts by weight of the active material (B), the amount of a solid content of the aqueous dispersion (A) is 0.5 to 30 parts by weight, and the amount of the conductive assistant (C) is 0.1 to 20 parts by weight.

3. The non-aqueous electrolyte secondary battery according to claim 1,
wherein, in the aqueous paste for an electrochemical cell (1) or in the aqueous paste for an electrochemical cell (2), the aqueous dispersion (A) comprises at least one kind selected from a surfactant (x) and a viscosity modifier (y).

4. The non-aqueous electrolyte secondary battery according to claim 3,
wherein based on 100 parts by weight of a solid content of the olefin copolymer (a), the amount of a solid content of the surfactant (x) is 0 to 100 parts by weight, and the amount of a solid content of the viscosity modifier (y) is 10 to 100 parts by weight.

5. The non-aqueous electrolyte secondary battery according to claim 3,
wherein the viscosity modifier (y) is at least one kind selected from carboxymethyl cellulose, polyethylene oxide, a modified product of polyethylene oxide, polyvinyl alcohol and a modified product of polyvinyl alcohol.

6. The non-aqueous electrolyte secondary battery according to claim 1,
wherein the spherical natural graphite has a median diameter (D50), as measured by laser diffraction scattering method, of 15 to 20 μm.

7. The non-aqueous electrolyte secondary battery according to claim 6,
wherein the spherical natural graphite has a specific surface area of 2 to 5 m²/g.

8. The non-aqueous electrolyte secondary battery according to claim 1,
wherein, in the aqueous paste for an electrochemical cell (1) or in the aqueous paste for an electrochemical cell (2), the conductive assistant (C) is at least one kind selected from acetylene black and artificial graphite.

9. The non-aqueous electrolyte secondary battery according to claim 8,
wherein the conductive assistant (C) has a specific surface area of 2 to 80 m²/g.

10. The non-aqueous electrolyte secondary battery according to claim 8,
wherein the acetylene black has a median diameter (D50), as measured by laser diffraction scattering method, of 0.02 to 5 μm.

11. The non-aqueous electrolyte secondary battery according to claim 8,
wherein the artificial graphite has a median diameter (D50), as measured by laser diffraction scattering method, of 2 to 80 μm.

12. The non-aqueous electrolyte secondary battery according to claim 1,
wherein, in the positive electrode plate for an electrochemical cell or in the negative electrode plate for an electrochemical cell, the electrode plate has an electricity capacity of 0.5 to 18 mAh/cm².

13. The non-aqueous electrolyte secondary battery according to claim 1,
wherein, in the positive electrode plate for an electrochemical cell, the packing density of the active material applied on the positive electrode plate is 1.0 to 2.0 g/cm³.

14. The non-aqueous electrolyte secondary battery according to claim 1,
wherein, in the negative electrode plate for an electrochemical cell, the packing density of the active material applied on the negative electrode plate is 1.0 to 1.7 g/cm³.

15. The non-aqueous electrolyte secondary battery according to claim 1,
wherein the aqueous dispersion for an electrochemical cell (A) used in the negative electrode plate for an electrochemical cell further comprises an acid-modified olefin (co)polymer (a-4) having a weight average molecular weight, as determined by gel permeation chromatography (GPC), of less than 50,000 (in terms of polystyrene).

16. A household storage battery comprising the non-aqueous electrolyte secondary battery according to claim 1.
